(19) United States
(12) Patent Application Publication
(10) Pub. No.: US 2026/0220976 A1
(43) Pub. Date: Jul. 30, 2026

(54) LINKING VEHICLE PARAMETERS TO MAINTENANCE ACTIONS

(71) Applicant: CPS Technology Holdings LLC, New York, NY (US)

(72) Inventors: John P. BANIA, Whitefish Bay, WI (US); Jason D. SEARL, Bayside, WI (US)

(21) Appl. No.: 19/144,249

(22) PCT Filed: Dec. 29, 2023
(86) PCT No.: PCT/US2023/086342

§ 371 Date: Jun. 27, 2025

Related U.S. Application Data
(60) Provisional application No. 63/477,704, filed on Dec. 29, 2022.

(51) Int. Cl. G07C 5/00; G06Q 10/20; G06Q 30/0601; G07C 5/08

(52) U.S. Cl. CPC G07C 5/006; G06Q 10/20; G06Q 30/0639; G07C 5/008; G07C 5/0808; G07C 5/0825

(57) ABSTRACT

A device configured to communicate with one or more of an accessory, a battery management system (BMS), and a server is described. The device includes processing circuitry configured to obtain one or more of a vehicle parameter, a battery parameter, and an accessory parameter from one or more of the accessory, the BMS, and the server. The processing circuitry is further configured to determine a maintenance parameter based on the one or more of the vehicle parameter, the battery parameter, and the accessory parameter. The processing circuitry is further configured to determine one or more maintenance actions based on the one or more determined maintenance parameters.

### TECHNICAL FIELD

This disclosure relates in particular to a method, apparatus, and system for linking of parameters to various maintenance actions.

### BACKGROUND

Motor-powered and/or electrically powered vehicles rely on various systems and components within the vehicle so that the vehicle can function efficiently, safely, and properly. Such vehicles may include one or more of an air or watercraft vehicle, a rail-guided vehicle, a street or road vehicle, etc., where a street or road vehicle may refer to, for example, one or more of cars, trucks, buses, recreational vehicles, all-terrain vehicle, off-road vehicle etc. There are various systems and components in the vehicle that allow the vehicle to function in an efficient, safe, and effective manner. However, when one or more of these systems and/or components fail to operate as intended, there can be negative results including safety, efficiency, and performance issues.

The various systems and components in the vehicle may require maintenance, care, and attention and may include battery systems, belts and hoses, braking systems, emission systems, engine cooling systems, exhaust systems, fluids and filters, fuel systems, lighting and wipers, steering and suspension, power train system, etc. A non-limiting example of other various systems and components that may also require care, maintenance, and attention is the battery system. Depending upon the type of vehicle, there may be one or more than one battery system to provide starting power (e.g., power used to crank and start and engine) and/or at least a portion of the motor power for the vehicle. The type of battery system(s) used in a vehicle may depend upon numerous factors including the type of engine in the vehicle, the type of vehicle, customization of the vehicle, and the operators driving style. The battery system(s) may have traction batteries (for electric or hybrid electric vehicles) and starter batteries as well. The starter battery may be used for providing the necessary energy/power required for starting the vehicle and the traction battery may generally refer to a battery which provides power to electric motors. Each type of battery system may have different requirements, maintenance, and other parameters so that each battery system is able to run efficiently and effectively. Further, manufacturers of batteries typically suggest replacing batteries after a predetermined time interval and may have specific maintenance suggestions relating to particular batteries.

However, some batteries may fail before the predetermined time interval for a variety of different reasons including manufacturing defects, environmental conditions, the type of driving occurring on the vehicle, the customization of the vehicle, and the frequency of the driving. If the battery in a vehicle fails for one reason or another this can result in inconvenience, safety conditions, and unexpected visits to battery replacement centers. Other systems and components of the vehicle may also fail before certain predetermined time internals for a variety of reasons including manufacturing defects, environmental conditions, the type of driving occurring on the vehicle, the customization of the vehicle and the frequency of the driving as well. The failure of these systems and components can also be inconvenient and cause safety issues. Further, the failure to conduct timely care and maintenance related to the systems and components to the vehicle can result in unnecessary expenses and the failure to the system, component, and/or the entire vehicle.

### SUMMARY

Existing vehicle systems and components lack the ability to timely and accurately predict the failure of a components and/or systems and the repair and replacement schedule for the particular vehicle component and/or system.

Some embodiments advantageously provide a method, apparatus, and system for a mobile application which may be configured to link parameters to various maintenance actions, e.g., link vehicle maintenance and vehicle diagnostics to battery replacement.

According to one aspect, a device configured to communicate with one or more of an accessory, a battery management system (BMS), and a server is described. The device comprises processing circuitry configured to obtain one or more of a vehicle parameter, a battery parameter, and an accessory parameter from one or more of the accessory, the BMS, and the server. The processing circuitry is further configured to determine a maintenance parameter based on the one or more of the vehicle parameter, the battery parameter, and the accessory parameter. The processing circuitry is further configured to determine one or more maintenance actions based on the one or more determined maintenance parameters.

In some embodiments, the vehicle parameter may be received from one or both of the accessory and the server.

In some other embodiments, the battery parameter may be received from the BMS.

In some embodiments, the battery parameter may be received from the accessory.

In some other embodiments, one or both of the vehicle parameter and the battery parameter may be received from the BMS via the accessory.

In some embodiments, one or both of the vehicle parameter and the battery parameter may include one or more original equipment manufacturer (OEM) maintenance schedules.

In some other embodiments, the one or more OEM maintenance schedules are user customizable based on one or more of the vehicle parameter, the battery parameter, and the accessory parameter.

In some embodiments, the vehicle parameter is one or more of vehicle spark plug performance, spark plug operation, and spark plug maintenance.

In some other embodiments, the battery parameter is one or more of battery performance, battery management, battery operation, battery maintenance, and battery health.

In some embodiments, the processing circuitry is further configured to assign a rank to each one of the vehicle parameter, the battery parameter, and the accessory parameter.

In some embodiments, the rank is based on one or more of a predetermined battery life cycle, a battery parameter threshold, a service promotion, a maintenance schedule, an alert, and a recall.

In some other embodiments, the one or more determined maintenance parameters include a suggested time for a service visit and a priority level associated with the one or more of the vehicle parameter, the battery parameter, and the accessory parameter.

In some embodiments, the one or more determined maintenance actions indicates a battery replacement.

In some other embodiments, the one or more determined maintenance actions further indicates at least one location to purchase a battery.

In some embodiments, the processing circuitry is further configured to identify a preset battery function and a preset vehicle parameter. The processing circuitry is further configured to trigger the one or more determined maintenance actions based on the preset battery function and the preset vehicle parameter and the one or more determined maintenance actions indicates a battery replacement.

In some other embodiments, the processing circuitry is further configured to identify a preset battery parameter and trigger the one or more determined maintenance actions based on the preset battery parameter. The one or more determined maintenance actions may indicate a replacement of at least one brake pad.

In some other embodiments, the one or more determined maintenance actions includes at least two vehicle maintenance services.

In some embodiments, the processing circuitry is further configured to identify a preset vehicle parameter for a vehicle alternator and trigger one maintenance action of the one or more determined maintenance actions based on the preset vehicle parameter. The one or more determined maintenance action may indicate a remaining life cycle of the battery.

In some other embodiments, the processing circuitry is further configured to download one or more maintenance schedules from the server.

In some embodiments, one or more of the processing circuitry is further configured to generate a maintenance action indicator. The maintenance action indicator one or more of notifies a user of the one or more maintenance actions which causes one or more of the accessory, the BMS, the server, and a vehicle system to perform another action which is included in a message transmitted by the device to one or more of the accessory, the BMS, the server, and a vehicle system and causes the device to display an alert for the user on the device. The other action includes one or both of scheduling a maintenance appointment and creating a record accessible by a service provider, the record indicating the one or more determined maintenance actions. The other action includes causing the BMS to switch to a predetermined operating mode. The other action includes causing the vehicle system to one or both of display another alert and disable or enable a driving mode.

According to one aspect, a device may be configured to communicate with one or more of an accessory, a battery management system (BMS), and a server. The device may comprise processing circuitry configured to obtain one or more of a vehicle parameter received from one of the accessory and the server, a battery parameter received from one of the BMS and the accessory, and an accessory parameter received from one or more of the accessory, the BMS, and the server. The processing circuitry may be further configured to obtain one or more of a vehicle function received from one of the accessory and the server, a battery function received from one of the BMS and the accessory, and an accessory function received from one or more of the accessory, the BMS, and the server. The processing circuitry may be configured to determine one or more maintenance parameters based on the one or more of the vehicle parameter, the battery parameter, and the accessory parameter and the one or more vehicle function, battery function, and accessory function. The processing circuitry is further configured to determine one or more maintenance actions based on the one or more determined maintenance parameters.

In some embodiments, one or both of the vehicle parameter and the battery parameter includes one or more original equipment manufacturer OEM maintenance schedules.

In some other embodiments, the one or more OEM maintenance schedules are user customizable based on one or both of the vehicle parameter and the battery parameter.

In some embodiments, the vehicle parameter is at least one of vehicle spark plug performance, spark plug operation, and spark plug maintenance.

In some other embodiments, the battery parameter is one or more of battery performance, battery management, battery operation, battery maintenance, and battery health.

In some embodiments, the processing circuitry is further configured to assign a rank to each one of the vehicle parameter, the battery parameter, and the accessory parameter.

In some other embodiments, the rank is based on one or more predetermined battery life cycle, a battery parameter threshold, a service promotion, a maintenance schedule, an alert, and a recall.

In some embodiments, the one or more maintenance parameters include a suggested time for a service visit and a priority level associated with the one or more of the vehicle parameter, the battery parameter, and the accessory parameter.

In some other embodiments, the one or more determined maintenance actions indicate a battery replacement.

In some embodiments, the one or more determined maintenance actions further indicate at least one location for the battery replacement.

In some other embodiments, the processing circuitry is further configured to assign another rank to each one of the vehicle function, the battery function, and the accessory function.

In some embodiments, one or more of the processing circuitry is further configured to generate a maintenance action indicator and the maintenance action indicator is one or more of notifying a user of the one or more maintenance actions and causing one or more of the accessory, the BMS, the server, and a vehicle system to perform another action. Also, being included in a message transmitted by the device to one or more of the accessory, the BMS, the server, and a vehicle system, the processing circuitry is further configured to cause the device to display an alert for the user on the device and the other action including one or both of scheduling a maintenance appointment and creating a record accessible by a service provider where the record indicates the one or more determined maintenance actions. The other action includes causing the BMS to switch to a predetermined operating mode and the other action includes causing the vehicle system to one or both of display another alert and disable or enable a driving mode.

According to one aspect, a method in a device may be configured to communicate with one or more of an accessory, a battery management system (BMS), and a server. The method may comprise obtaining one or more of a vehicle parameter, a battery parameter, and an accessory parameter from one or more of the accessory, the BMS, and the server. The method may comprise determining one or more maintenance parameters based on the one or more of the vehicle parameter, the battery parameter, and the accessory parameter. The method may also comprise determining one or more maintenance actions based on the one or more determined maintenance parameters.

In some embodiments, the method further includes assigning a rank to each one of the vehicle parameter, the battery parameter, and the accessory parameter.

In some other embodiments, the rank is based on one or more of a predetermined battery life cycle, a battery parameter threshold, a service promotion, a maintenance schedule, an alert, and a recall.

In some embodiments, the method further includes identifying a preset battery function and a preset vehicle parameter and triggering the one or more determined maintenance actions based on the preset battery function and the preset vehicle parameter, the one or more determined maintenance actions indicates a battery replacement.

In some other embodiments, the method further includes identifying a preset battery parameter and triggering the one or more determined maintenance actions based on the preset battery parameter, the one or more determined maintenance actions indicate a replacement of at least one brake pad.

In some embodiments, the method further includes identifying a preset vehicle parameter for a vehicle alternator and triggering one maintenance action of the one or more determined maintenance actions based on the preset vehicle parameter, the one maintenance action indicating a remaining life cycle of the battery.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a diagram of an example system according to principles disclosed herein;

FIG. 2 shows an example battery constructed in accordance with the principles of the present disclosure;

FIG. 3 a block diagram of some entities in the system according to some embodiments of the present disclosure;

FIG. 4 is a block diagram of an example server according to some embodiments of the present disclosure;

FIG. 5 shows an example screen according to some embodiments of the present disclosure;

FIG. 6 shows example navigation options according to some embodiments of the present disclosure;

FIG. 7A shows a first portion of an example navigation profile according to some embodiments of the present disclosure;

FIG. 7B shows a second portion of an example navigation profile according to some embodiments of the present disclosure;

FIG. 8 shows example dashboard pages and features according to some embodiments of the present disclosure;

FIG. 9 shows example battery setup pages according to some embodiments of the present disclosure;

FIG. 10 shows example battery screen according to some embodiments of the present disclosure;

FIG. 11 shows example maintenance screens according to some embodiments of the present disclosure;

FIG. 12A shows an example first portion of a screen navigation structure according to some embodiments of the present disclosure;

FIG. 12B shows an example second portion of the screen navigation structure according to some embodiments of the present disclosure;

FIG. 13A shows another example of a first portion of a screen navigation associated with the vehicle according to some embodiments of the present disclosure; and

FIG. 13B shows another example of a second portion of the screen navigation associated with the vehicle according to some embodiments of the present disclosure; and

FIG. 13C shows another example of a third portion of the screen navigation associated with the vehicle according to some embodiments of the present disclosure; and

FIG. 14 shows a flowchart of an example process in a device according to some embodiments of the present disclosure; and

FIG. 15 shows another example flowchart of an example process in a device according to some embodiments of the present disclosure.

### DETAILED DESCRIPTION

Before describing in detail exemplary embodiments, it is noted that the embodiments reside primarily in combinations of apparatus components and processing steps related to a method, apparatus, and system for linking various parameters to various actions, including maintenance actions, and parameters. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In some embodiments, the term “smart battery” may be used and may refer to a battery having, for example, lead, lithium or sodium chemistries, that are enabled by electronics physically attached to the battery for monitoring battery functional parameters, such as but not limited to state of charge, state of health and/or trends thereof, or communicating battery conditions internally within or externally from the battery environment. The electronics may be generally referred to as connected electronics and may include a battery management system or any other electronic component. Further, electronics may utilize wired or wireless transmission devices or communication interfaces configured for communication of data and/or information, such as applicable battery information and/or derivatives of the battery information.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term “smart battery” may be used and may refer to a battery having, for example, lead, lithium or sodium chemistries, which are enabled by electronics physically attached to the battery for monitoring battery functional parameters, such as state of charge, state of health and/or trends thereof, or communicating battery conditions internally within or externally from the battery environment. The electronics may be generally referred to as connected electronics and may include a battery management system or any other electronic component. Further, electronics may utilize wired or wireless transmission devices or communication interfaces configured for communication of data and/or information, such as applicable battery information and/or derivatives of the battery information.

The term “parameter” refers to any parameter related to any system or component of the vehicle that can be set. As one example of a parameter in the vehicle, the parameter may relate to a battery (and/or its components), battery performance, battery management, battery operation, battery maintenance, battery health, battery replacement. The parameter relating to the battery may also be tied to other systems and/or components in the vehicle as well including but not limited to vehicle diagnostic parameters, accessory systems parameters, parameter variation, etc. Further, the parameter may be associated with a plurality of parameter values that are within a range in which a component and/or system functions and/or may be intended or expected to function. A parameter may refer to quantities that define a theoretical model. The maintenance parameter may refer to any parameter and/or more than one parameter from the vehicle parameter, battery parameter, and/or accessory parameter that is set which indicates that some sort of maintenance action may be required and/or expected for the vehicle in the near future.

For example, a vehicle parameter may be any parameter associated with any system and/or component of the vehicle. For example, a vehicle parameter may include any setting related to the powertrain, the engine, the ignition, the electrical system, the transmission/drive train, the alternator, the radiator, the axles, the steering and suspension, the catalytic converter, the muffler/exhaust system, the tailpipe, the fuel system and tank, the frame and the body.

For example, a battery parameter may be any parameter associated with any system and/or component of the battery. For example, a battery parameter may include an electrical parameter such as a waveform, power, voltage, voltage, current, state of charge (SoC), state of health (SoH), open circuit voltage (OCV), voltage drop, a time, resistance value, and/or any other parameter such as temperature, pressure, and/or frequency parameters (e.g., frequency of a pulse, frequency at which an operation mode is on and/or off and/or activated and/or deactivated), etc.

For example, an accessory parameter may be any parameter associated with any system and/or component of the accessory. An accessory parameter may include, but is not limited to, parameter settings related to, but not limited to, fuel and air metering, the vehicle's fuel milage and emissions systems, air-to-fuel rations/ratios in the vehicle, sensing oxygen within the vehicle, the fuel injector including the fuel injector circuit, any engine misfiring including parts like spark plugs, ignition parts, auxiliary emissions controls including the evaporative emission control system, vehicle speed controls and idle control systems including the vehicle speed sensor, any computer output circuit problems and any faulty computer system issues, the transmission system and any related components. Furthermore, the accessory parameters may include, but not limited to settings related to the front, side, rear, and any additional passenger airbag systems, seat belt tension systems, body sensors around the vehicle, power door locks, ignition systems, brake lamps, keyless entry functions, driver and passenger side seats, climate control systems, power systems including the windshield wipers and sprayers, electrical circuit issues and power supply issues/problems, auxiliary heaters and interior fans, airbag sensors, and transmission temperatures. Also, the accessory parameters may include setting relating to braking systems, steering systems, suspension systems, traction control systems, the vehicle speed sensor, the brake pedal positions sensor, the pressure systems, the steering wheel position, the anti-lock braking system (ABS) function, the driving torque delivery from the engine to the wheels, the vehicle's mechanical systems including the ABS sensors, the wheel sensors, the park breaks, the vehicle accelerometer circuits, and the dynamic stability control systems, and monitoring the air suspension system. Finally, accessory parameters may include settings related to low and/or high circuit voltage in the controller area network or the vehicle area network, the antilock braking system, the transmission control module, the navigation control systems, the network software and network data, the control modules related to the braking system, the gear shift, and the steering effort, the engine temperature controls, the ignition systems, the power windows and door functions, the audio and infotainment systems including audio speakers, Bluetooth systems, and navigation systems, and the control module and power distribution systems including circuit issues, power control module, ignition input, and switch systems. These are not meant as limiting examples and demonstrate that the accessory parameters.

When addressing any of the parameters related to any systems and/or component of the vehicle, a frequency parameter may refer to a setting related to a time parameter such as the time a pulse is on or off, the time an operation mode is on/off and/or /tivated/ deactivated. Also, a parameter threshold may refer to a setting related to a threshold associated with a parameter. Additionally, it will be understood that the parameters may be for other systems and/or components in the vehicle including belts/hoses, brakes, filters, fluids, emissions, engine cooling, exhaust, filters and fluids, the fuel system, lighting and wipers, streeting and suspension, and the transmission.

A “function” may refer to the way in which a system or component of the vehicle is actually operating at a certain time or for a certain period of time. The function may refer to anything that may be measured and/or quantified related to the vehicle, battery, and/or accessory. An example of a function in the vehicle may relate to the battery (and/or its components) and the function may measure an electrical function of the battery including the waveform, power, voltage, voltage, current, SoC, SoH, OCV, resistance value, and/or any other function of the vehicle such as temperature, pressure, and/or frequency (e.g., frequency of a pulse, frequency at which an operation mode is on and/or off and/or activated and/or deactivated), etc. The function may relate to any other component and/or system of the vehicle as well.

For example, a vehicle function may be any function associated with any system and/or component of the vehicle. For example, a vehicle function may include anything that can be measured including the powertrain, the engine, the ignition, the electrical system, the transmission/drive train, the alternator, the radiator, the axles, the steering and suspension, the catalytic converter, the muffler/exhaust system, the tailpipe, the fuel system and tank, the frame and the body.

For example, a battery function may be any function associated with any system and/or component of the battery. As a non-limiting example, a battery function may include anything that can be measured including an electrical function such as a waveform, power, voltage, voltage, current, SoC, SoH, OCV, voltage drop, a time, resistance value, and/or any other function such as temperature, pressure, and/or frequency functions (e.g., frequency of a pulse, frequency at which an operation mode is on and/or off and/or activated and/or deactivated), etc.

For example, an accessory function may be any function associated with any system and/or component of the accessory. As non-limiting examples, an accessory function may include anything that can be measured including, but not limited to, fuel and air metering, monitoring of the vehicle's fuel milage and emissions systems, monitoring air-to-fuel rations/ratios in the vehicle, sensing oxygen within the vehicle, monitoring the fuel injector including the fuel injector circuit, monitoring any engine misfiring including parts like spark plugs, ignition parts, monitoring auxiliary emissions controls including the evaporative emission control system, vehicle speed controls and idle control systems including the vehicle speed sensor, monitoring for any computer output circuit problems and any faulty computer system issues, monitoring the transmission system and any related components. Furthermore, the accessory functions may include, but are not limited to monitoring front, side, rear, and any additional passenger airbag systems, monitoring seat belt tension systems, monitoring body sensors around the vehicle, monitoring power door locks, monitoring ignition systems, monitoring brake lamps, monitoring keyless entry functions, monitoring the driver and passenger side seats, monitoring climate control systems, monitoring power systems including the windshield wipers and sprayers, monitoring electrical circuit issues and power supply issues/problems, monitoring of auxiliary heaters and interior fans, monitoring airbag sensors, and transmission temperatures. Also, the accessory functions may include monitoring of braking systems, monitoring of steering systems, monitoring of suspension systems, monitoring of traction control systems, monitoring of the vehicle speed sensor, monitoring of the brake pedal positions sensor, monitoring of the pressure systems, monitoring of the steering wheel position, monitoring of the anti-lock braking system (ABS) function, monitoring of the driving torque delivery from the engine to the wheels, monitoring of the vehicle's mechanical systems including the ABS sensors, the wheel sensors, the park breaks, the vehicle accelerometer circuits, and the dynamic stability control systems, and monitoring the air suspension system. Finally, the accessory functions may include monitoring low and/or high circuit voltage in the controller area network or the vehicle area network, monitoring the antilock braking system, monitoring the transmission control module, monitoring the navigation control systems, monitoring network software and network data, monitoring the control modules related to the braking system, the gear shift, and the steering effort, monitoring the engine temperature controls, monitoring the ignition systems, monitoring the power windows and door functions, monitoring the audio and infotainment systems including audio speakers, Bluetooth systems, and navigation systems, and monitoring control module and power distribution systems including circuit issues, power control module, ignition input, and switch systems. These are not meant as limiting examples and demonstrate that the accessory functions.

A “health condition” may refer to any condition associated with at least one system and/or component of the vehicle. As one example, a health condition related to the battery and/or a battery health condition may refer to any condition associated with a battery (and/or devices, systems, components associated with the battery such as health of the battery and/or of a vehicle/vehicle system). A battery health condition may include a failure of the battery (e.g., a catastrophic failure of a battery/system, a potential failure, a condition associated with a potential failure, a triggered system failures, a battery pack failure, fail to start/operate vehicle, etc.), a degradation condition (e.g., inability to meet a user/functional/specification requirement such as when a parameter is under/over a predetermined threshold), an internal short circuit, an internal resistance value being under a predetermined threshold (e.g. indicating a short circuit condition), etc. Additionally, a health condition may also refer to any other system or component of the vehicle as well. A vehicle may have a variety of health conditions which relate to different components and/or systems of the vehicle. Further, a health condition may include a condition associated with SoH of the battery.

SoH may refer to a parameter that indicates the level of degradation and/or remaining capacity of the battery. In some embodiments, SoH may indicate a difference between the health of a new battery and the health of a used battery. In some other embodiments, SoH may be defined as a ratio of the maximum battery charge to the rated capacity and may be expressed as a percentage.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

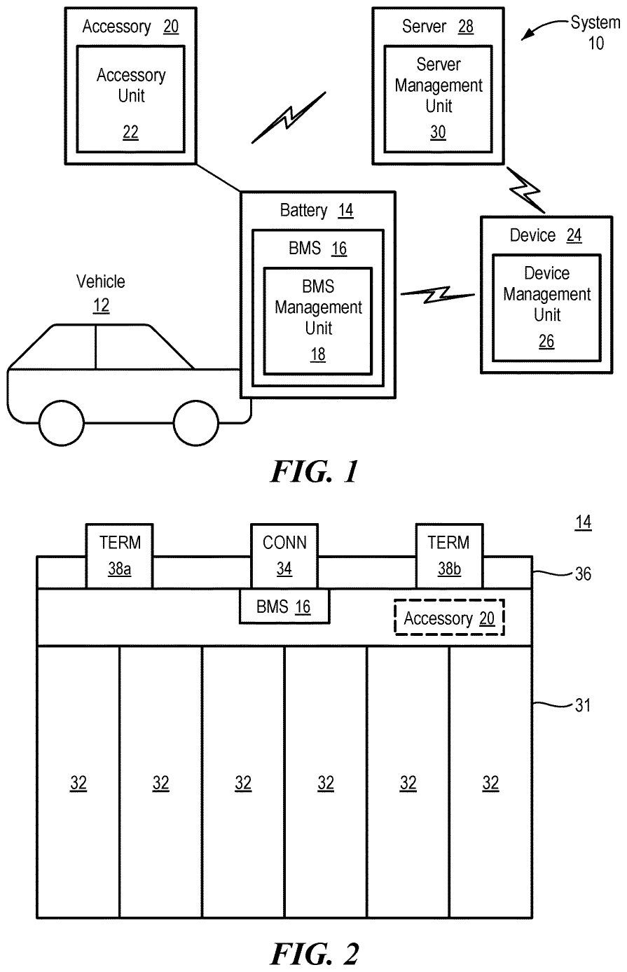

Referring to the drawing figures, in which like elements are referred to by like reference numerals, there is shown in FIG. 1 a diagram of a system 10, according to an embodiment, which comprises one or more of a vehicle 12, a battery 14, an accessory 20, a device 24, and a server 28. Vehicle 12 may be any type of vehicle such as a vehicle usable for transporting persons, animals, goods, products, etc. In a nonlimiting example, vehicle 12 may include a car, motorcycle, scooter, truck, golf cart, buses, motorized wheelchair, light utility vehicle, railed vehicles such as trains and trams, watercrafts including ships, boats and underwater vehicles, aircrafts including planes and helicopters, spacecrafts, self-driving vehicles, or any other type of vehicle.

The vehicle 12 includes at least one battery 14 for powering at least one function of vehicle 12. In some embodiments, battery 14 may be a lead-acid battery that includes one or more energy storage modules/cells. Although a lead-acid battery has been described, the teachings described herein are equally applicable to other battery types as well. Battery 14 may include one or more batteries such as a first battery 14a, second battery 14b, third battery 14c, fourth battery 14d, etc., e.g., electrically connected (e.g., in parallel, series, etc.) as part of a battery pack. Battery 14 may also include a BMS 16 that is configured to perform one or more battery management functions/battery functions described herein. The BMS 16 may comprise a BMS management unit 18, which may be configured to perform any step, and/or task, and/or process, and/or method, and/or feature described in the present disclosure e.g., BMS 16 functions. In some embodiments, the BMS 16 may measure/determine certain battery parameters as well as functions and transmit/receive data (and/or signals such as control signals) to/from another system/device. The BMS 16 is configured to include a BMS management unit 18 that may be configured to perform one or more functions as described herein such as battery management functions.

The accessory 20 may include an accessory unit 22, which may be configured to perform any step and/or task and/or process and/or method and/or feature described in the present disclosure e.g., accessory 20 functions. For example, accessory unit 22 may be configured to perform one or more functions as described herein such as determining, receiving, and/or transmitting one or more parameters, determine the function of one or more components/systems of the vehicle, or any other information associated with vehicle 12, battery 14, server 28, any accessory 20, and/or another device 24. For example, where accessory 20 comprises On-Board Diagnostics (OBD) device, accessory unit 22 may be configured to determine one or more accessory 20 functions, e.g., using the OBD device. The OBD device may be configurable to monitor and/or control vehicle 12, battery 14, BMS 16, etc. Further, the OBD device may be able to provide information about a variety of different accessory functions and accessory parameters related to various systems and components of the vehicle 12.

Accessory 20 may be physically and/or electrically connected to one or more components of the system 10 including the vehicle 12, battery 14, BMS 16, device 24, server 28, e.g., and provide one or more parameters and/or functions, including accessory parameters and functions which are monitored or controlled by accessory 20. Device 24 may include a device management unit 26, which may be configured to perform any of the one or more functions, tasks, processes, methods, and/or features as described herein, e.g., device functions. For example the device management unit 26 may be configured to determine one or more functions, parameters, and/or linking of certain functions and/or parameters together as well. For example, vehicle maintenance and/or vehicle diagnostics may be linked to the battery life cycle and/or used in determining one or more actions associated with battery life cycle and/or information associated with the vehicle 12, battery 14, and/or any accessory 20. Device 24 may also comprise software such as a mobile application configured to render one or more user interfaces that may facilitate performing one or more actions described in the present disclosure. Further, the device 24 may be a computing device (e.g., personal computer, laptop, etc.) or a mobile device (e.g., a cellular phone or tablet) any of which may be configured to perform the one or more functions associated with device 24 as described herein.

The server 28 may include the server management unit 30, which may be configured to perform any step and/or task and/or process and/or method and/or feature described in the present disclosure, e.g., server 28 functions. For example, server management unit 30 may be configured to perform one or more functions as described herein such as determining, receiving, and/or transmitting one or more parameters, conditions, functions, or any other information and/or data associated with vehicle 12, battery 14, and/or any accessory 20.

It is contemplated that one or more entities of system 10 are in communication with each other via one or more of wireless communication, power communication, wired communication, etc. For example, vehicle 12, battery 14, accessory 20, device 24, and server 28 may communicate with each other directly or indirectly using wireless communication, power communication, wired communication, etc. and/or any communication protocol. Further, although battery 14 is shown as part of vehicle 12 may be a standalone battery, removably couplable to any component of system 10 such as vehicle 12, etc.

FIG. 2 shows an example battery 14 constructed in accordance with the principles of the present disclosure. Battery 14 includes a housing 31 into which one or more battery components, such as battery cells 32, may be positioned. The components may be electrically interconnected (not shown in the FIGS), such as via an electrically conductive bus bar system which electrically interconnects the components in an electrically serial, electrically parallel, or combination of electrically serial and parallel manner, depending on the intended voltage and current requirements. Although FIG. 2 shows six cells 32, it is understood that fewer or greater than six cells can be used in battery 14 depending on design requirements.

The BMS 16 may be included as part of the battery 14. BMS 16 may include a monitoring connector 34 that allows for a removable external connection with any other component of system 10 (e.g., to the vehicle's data bus, to some other communication device, accessory 20, etc.) and/or internal connection, e.g., any components of battery 14 and/or BMS 16 and/or accessory 20. Connector 34 may be in direct/indirect communication with the BMS 16, accessory 20, server 28 and/or device 24. In some embodiments, connector 34 may be configured to removably couple and/or connect (electrically, physically) to another connector. The monitoring connector 34 can, in some embodiments, be integrated with the housing 31, such as in a cover 36 of the housing 31. BMS 16 may also be able to wirelessly communicate with other devices to communicate/exchange information and/or data. Battery 14 also includes terminals, such as a positive terminal 38a and a negative terminal 38b (collectively referred to as terminals 38) to provide the contact points for electrical connection of the battery 14 (e.g., to accessory 20 such as to power accessory 20, to the vehicle 12 such as to provide power to the vehicle and/or BMS 16 such as to power BMS 16). Terminals 38 may be arranged to protrude through housing 31, such as protruding through cover 36. Terminals 38 may be electrically connected to the bus bars inside housing 31 and/or directly connected to cells 32 (bus bars and direct connection not shown).

Further, battery 14 may be arranged to provide power capacities to many different physical sizes, and to operate under various preset parameters and parameter ranges. It is also noted that implementations of battery 14 may be scaled to provide various capacities. For example, in some embodiments, the power capacity, e.g., the battery function, of battery 14 can range from 25 Ah to 75 Ah. It is noted, however, that this range is merely exemplary, and that it is contemplated that embodiments of battery 14 can be arranged to provide less than a 25 Ah capacity or more than a 75 Ah capacity as well. Power capacity scaling can be accomplished, for example, by using higher or lower power capacity cells 32 in the housing 31, and/or by using fewer or more cells 32 in the housing 31. In some embodiments, battery 14 may be incorporated as part of a vehicle where battery power is needed. Other electrical parameters of the battery 14 can be adjusted/accommodated by using cells 32 that may cumulatively have the desired operational characteristics, e.g., current, voltage, charge, charging capacity/rate, discharge rate, etc. Thermal properties can be managed based on cell 32 characteristics, the use of heat sinks and/or thermal energy discharge plates, etc., within or external to the housing 31. Further, BMS 16 and/or accessory 20 may be connected to at least one of the cells such as to determine/measure at least one parameter of battery 14 and/or cells 32.

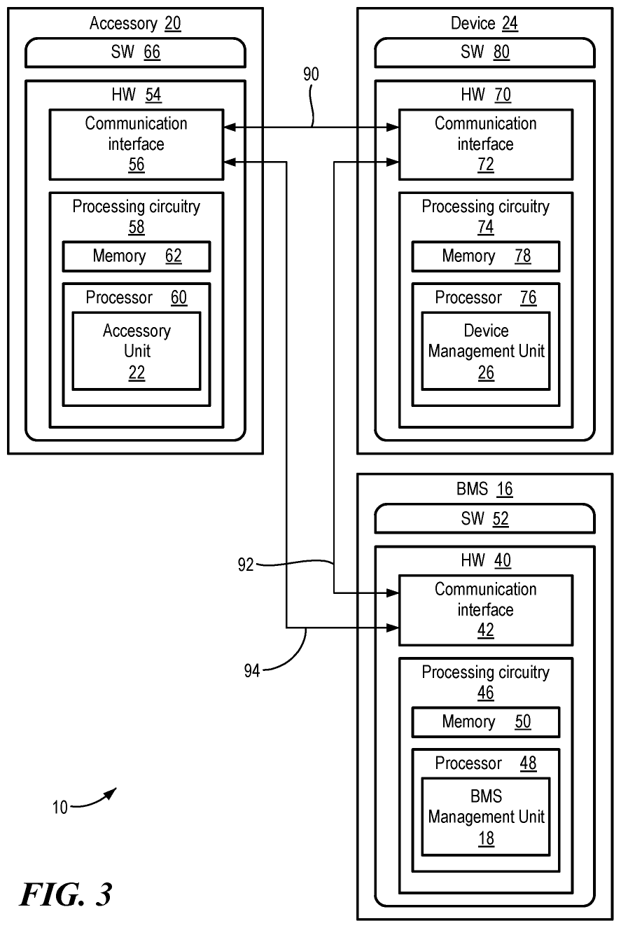

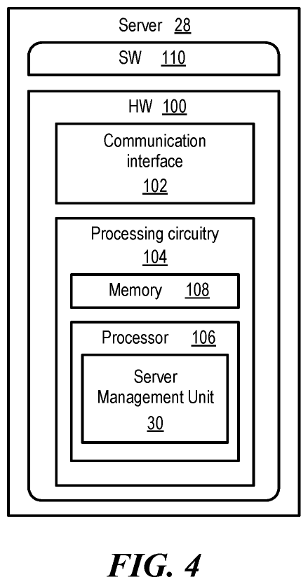

Example implementations, in accordance with an embodiment, of BMS 16, accessory 20, device 24, and server 28 discussed in the preceding paragraphs will now be described with reference to FIGS. 3 and 4. BMS 16 may have hardware 40 that may include a communication interface 42 that is configured to communicate with one or more entities in system 10 or outside the system 10 via wired and/or wireless communication. The communication may be protocol based communications.

The hardware 40 that is part of the BMS 16 includes processing circuitry 46. The processing circuitry 46 may include a processor 48 and memory 50. In particular, in addition to or instead of the processor 48, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 48 may be configured to access (e.g., write to and/or read from) memory 50, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the BMS 16 may further comprise software 52, which is stored in, for example, memory 50, or stored in external memory (e.g., database, etc.) accessible by the BMS 16. The software 52 may be executable by the processing circuitry 46. Further, software 52 may include a mobile application configured to render one or more user interfaces that may facilitate performing one or more actions described in the present disclosure.

The processing circuitry 46 may be configured to control any of the methods and/or processes described herein and/or to cause such methods, and/or processes to be performed, e.g., by BMS 16. The processor 48 corresponds to one or more processors 48 for performing BMS 16 functions described herein. The BMS 16 includes memory 50 that is configured to store data, programmatic software code, and/or other information described herein. In some embodiments, the software 52 may include instructions that, when executed by the processor 48 and/or processing circuitry 46, causes the processor 48 and/or processing circuitry 46 to perform the processes described herein with respect to BMS 16. For example, the processing circuitry 46 of the BMS 16 may include BMS management unit 18 that is configured to perform any step, and/or task, and/or process, and/or method and/or feature described in the present disclosure, e.g., BMS functions and/or battery functions. This may include the determination of one or more parameters associated with battery 14 and/or the measuring/evaluation of one or more functions associated with the battery 14. While BMS management unit 18 is illustrated as being part of BMS 16, BMS management unit 18 and associated functions and parameters described herein may be implemented in a device separate from BMS 16 such as in battery 14 or another device as well.

Accessory 20 (e.g., OBD device) may have hardware 54 that may include a communication interface 56 that is configured to communicate with one or more entities in system 10 (and/or outside of system 10) via wired and/or wireless communication. The communication may be protocol based communication. For example, accessory 20 may be configured to electrically connect to vehicle 12 and/or battery 14 and/or transmit/receive at least one parameter (and/or parameter data) and/or transmit/receive at least one function. Similarly, accessory 20 may be configured to wirelessly connect to any component of system 10 such as device 24 and/or transmit/receive at least one parameter (and/or parameter data) and/or transmit/receive at least one function.

The hardware 54 associated with accessory 20 includes processing circuitry 58. The processing circuitry 58 may include a processor 60 and memory 62. In particular, in addition to or instead of a processor, such as a central processing unit, and memory, the processing circuitry 58 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 60 may be configured to access (e.g., write to and/or read from) memory 62, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

The accessory 20 may further comprise software 66, which is stored in, for example, memory 62, or stored in external memory (e.g., database, etc.) accessible by the accessory 20. The software 66 may be executable by the processing circuitry 58.

The processing circuitry 58 may be configured to control any of the methods and/or processes described herein and/or to cause such methods, and/or processes to be performed, e.g., by accessory 20. The processor 60 corresponds to one or more processors 60 for performing accessory 20 functions described herein. The accessory 20 includes memory 62 that is configured to store data, programmatic software code and/or other information described herein. In some embodiments, the software 66 may include instructions that, when executed by the processor 60 and/or processing circuitry 58, causes the processor 60 and/or processing circuitry 58 to perform the processes described herein with respect to accessory 20. For example, the processing circuitry 58 of accessory 20 may include accessory unit 22, which may be configured to perform any step, and/or task, and/or process, and/or method, and/or feature described in the present disclosure e.g., accessory 20 functions. For example, accessory unit 22 may be configured to perform one or more functions as described herein such as determining, receiving, and/or transmitting one or more parameters, one or more functions, or any other information/data associated with vehicle 12, battery 14, and or any accessory 20. In some embodiments, accessory 20 and/or any of its components may be comprised in BMS 16 (and/or battery 14 and/or vehicle 12) and/or be powered by BMS 16 (and/or battery 14 and/or vehicle 12).

Further, the device 24 includes hardware 70, and the hardware 70 may include a communication interface 72 for performing wired and/or wireless communication with BMS 16 and/or accessory 20 and/or any other device or part of the system 10. For example, communication interface 72 of device 24 may communicate with communication interface 56 of accessory 20 via communication link 90. In addition, communication interface 72 of device 24 may communicate with communication interface 42 of BMS 16 via communication link 92. Similarly, communication interface 42 may communicate with communication interface 56 via communication link 94. At least one of communication links 90, 92, 94 may refer to a wired/wireless connection (such as WiFi, Bluetooth, etc.).

In the embodiment shown, the hardware 70 of device 24 includes processing circuitry 74. The processing circuitry 74 may include a processor 76 and a memory 78. In particular, in addition to or instead of a processor, such as a central processing unit, and memory, the processing circuitry 74 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 76 may be configured to access (e.g., write to and/or read from) the memory 78, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the device 24 further has software 80 stored internally in, for example, memory 78, or stored in external memory (e.g., database, etc.) accessible by the device 24 via an external connection. The software 80 may be executable by the processing circuitry 74. The processing circuitry 74 may be configured to control any of the methods and/or processes described herein and/or to cause such methods, and/or processes to be performed, e.g., by device 24. Processor 76 corresponds to one or more processors 76 for performing device 24 functions described herein. The memory 78 is configured to store data, programmatic software code, and/or other information described herein. In some embodiments, the software 80 may include instructions that, when executed by the processor 76 and/or processing circuitry 74, causes the processor 76 and/or processing circuitry 74 to perform the processes described herein with respect to device 24. For example, processing circuitry 74 of device 24 may include device management unit 26, which may be configured to perform one or more functions, tasks, processes, methods, and/or features as described herein, e.g., device 24 functions. For example, the device management unit 26 may be configured to determine one or more parameters, one or more functions, and/or linking vehicle maintenance and vehicle diagnostics to battery life cycle and/or determining one or more actions associated with battery life cycle or any other information associated with vehicle 12, battery 14 and/or accessory 20.

FIG. 4 shows an exemplary server 28, which may be in communication with any components of system 10, including but not limited to those as shown in FIG. 3. More specifically, server 28 includes hardware 100, and the hardware 100 may include a communication interface 102 for performing wired and/or wireless communication with any one of the components of system 10, such as communication interface 42 of BMS 16, communication interface 56 of accessory 20, and communication interface 72 of device 24, and/or any other device.

In the embodiment shown in FIG. 4, the hardware 100 of server 28 includes processing circuitry 104. The processing circuitry 104 may include a processor 106 and a memory 108. In particular, in addition to or instead of a processor, such as a central processing unit, and memory, the processing circuitry 104 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 106 may be configured to access (e.g., write to and/or read from) the memory 108, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the server 28 further has software 110 stored internally in, for example, memory 108, or stored in external memory (e.g., database, etc.) accessible by the server 28 via an external connection. The software 110 may be executable by the processing circuitry 104. The processing circuitry 104 may be configured to control any of the methods and/or processes described herein and/or to cause such methods, and/or processes to be performed, e.g., by server 28. Processor 106 corresponds to one or more processors 106 for performing server 28 functions described herein. The memory 108 is configured to store data, programmatic software code and/or other information described herein. In some embodiments, the software 110 may include instructions that, when executed by the processor 106 and/or processing circuitry 104, causes the processor 106 and/or processing circuitry 104 to perform the processes described herein with respect to server 28. For example, processing circuitry 104 of server 28 may include server management unit 30, which may be configured to perform any step, and/or task, and/or process, and/or method, and/or feature described in the present disclosure, e.g., server 28 functions. For example, one or more server 28 functions as described herein. For example, server management unit 30 may be configured to perform one or more functions as described herein such as determining, receiving, and/or transmitting one or more parameters and/or one or more functions, or any other information associated with vehicle 12, battery 14, and/or any accessory 20.

Although FIGS. 1, 3, and 4 show one or more “units” such as BMS management unit 18, accessory unit 22, device management unit 26, and server management unit 30 as being within a respective processor 48, 60, 76, 106, it is contemplated that these units may be implemented such that a portion of the unit is stored in a corresponding memory within the processing circuitry. In other words, the units may be implemented in hardware, software or in a combination of hardware and software within the processing circuitry.

Having described the general process flow of arrangements of the disclosure and having provided examples of hardware and software arrangements for implementing the processes and functions of the disclosure. The sections below provide details and examples of linking of parameters, functions, and other information and/or data to various maintenance actions.

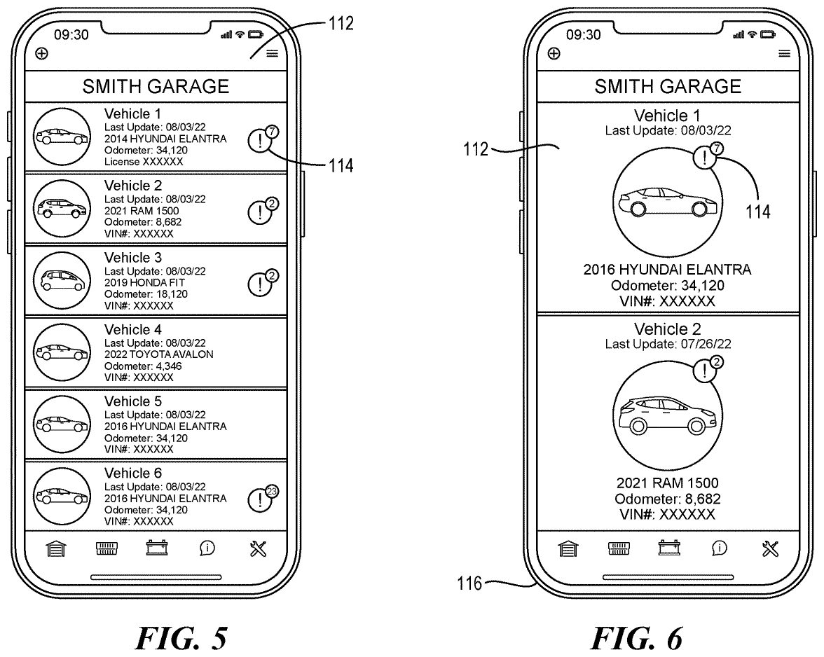

FIGS. 5 and 6 are exemplary displays 112 associated with software 80 showing a fleet/list layout that provides information about several vehicles which can be viewed on a display 112 in which images and data are shown. In some embodiments, display 112 may refer to a screen and/or display or more than one screen and/or display. Additionally, software 80 may include a mobile application configured to render one or more displays 112. The embodiments are not limited as such and the functions described herein may also be performed by any of the software 52, 66, 80, and 110. The display 112 could be any type of display 112 to visually present the information and in this embodiment is a cell/smart phone screen. It will be understood that the display 112 could show information related to one vehicle or more than one vehicle as well including but not limited to showing information related to 1 car, a 2-car layout, a four-car grid/layout, and a fleet/list layout. The display 112 may include a maintenance action indicator 114 which when activated and opened will have information about any proposed maintenance actions that have come up related to the specific vehicle 12 once the parameters, functions, and/or other information and/or data are synthesized by the system 10. Also, the maintenance action indicator 114 may have a number which is associated with how many maintenance actions are suggested for the particular vehicle 12. For example, the maintenance actions may include break replacement, battery replacement, and a check of the alternator. The information that is readable on display 112 may be customized or there may be preset settings as to what is displayed on the display 112. Also, the display 112 may include at least one icon 116 and the icons 116 can be customized as to which icons 116 are displayed on the display 112 and to remove icons 116 from the display as well. For example, the user can select which icons 116 are visible and by accessing and opening the icons 116 detailed information can be provided about the vehicle 12. As one example, the icon 116 may have an image of a battery and opening the battery icon 116 may provide details and information about the battery 14 in the vehicle 12.

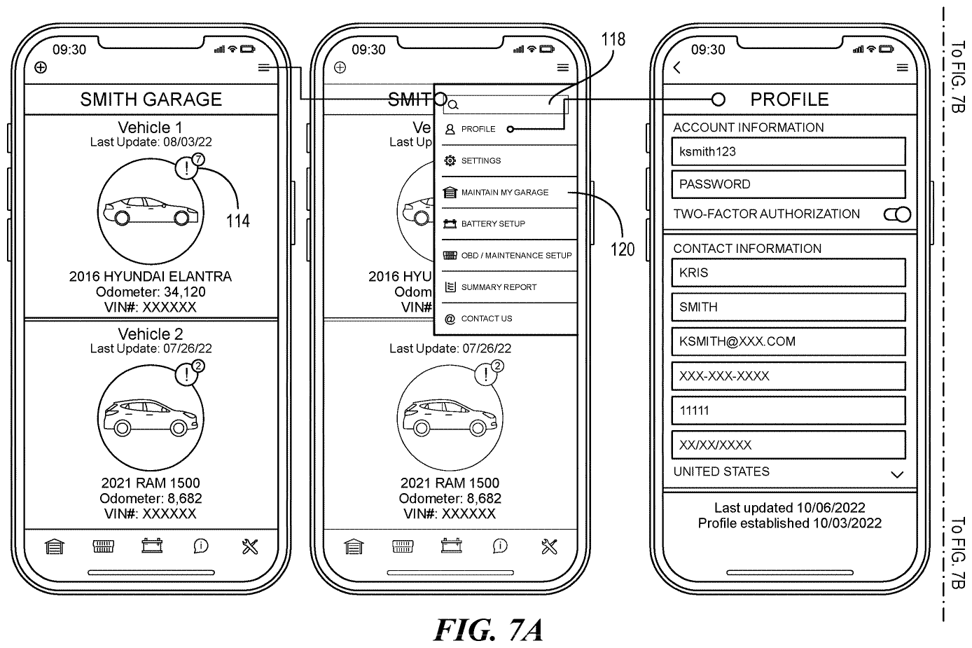

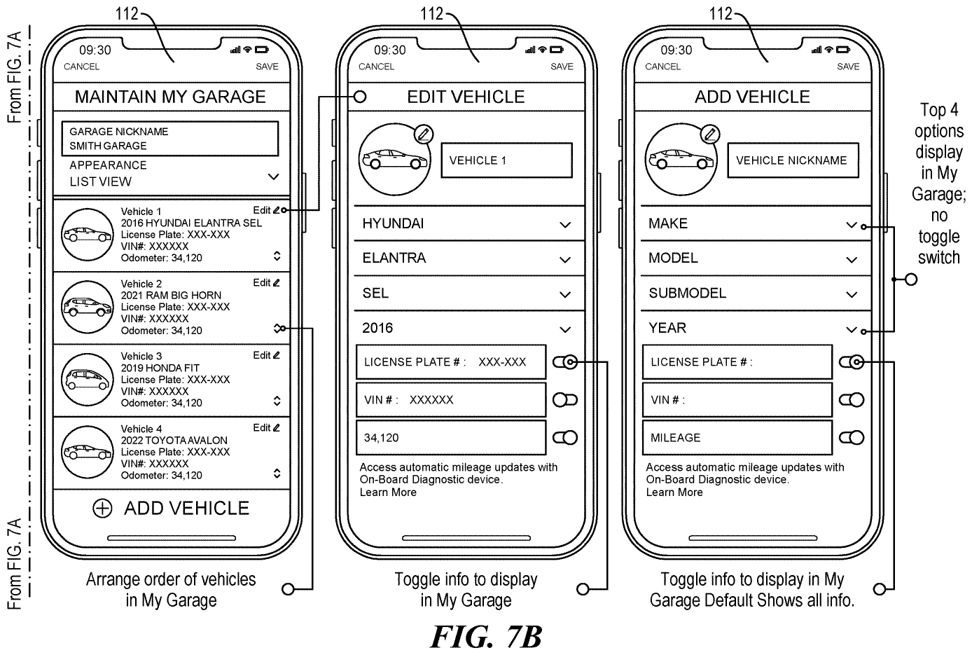

FIGS. 7A and 7B show an exemplary navigation profile which may be provided by software 80 and/or used with the system 10. Although the exemplary navigation profile is shown in FIGS. 7A and 7B, it will be understood that the navigation profile may be found in one profile. In FIG. 7A, the navigation profile includes a searching feature 118 where the user can search for a particular vehicle 12 as well as other specific information related to the vehicle 12. The navigation profile may include various options 120 related to each vehicle 12 and as shown one exemplary option 120 may include the profile of the user for the particular vehicle 12. The profile may include information like account information with a username and password along with contact information with the full name, email address, telephone number, zip code, birth date, country, and other related information for the profile. The profile may also have two-factor authentication as well and indicate when the profile was last updated along with the date the profile was established. As shown in FIG. 7B, the profile may also include the option 120, e.g., to “maintain my garage”. As shown in this exemplary embodiment, the maintain my garage option 120 may include information about the garage name for the vehicles and by clicking on the individual vehicles listed in the “maintain my garage” option 120, the user can input information in about the vehicle include the make, model, year, the VIN number, license plate number, milage, and other related information. The user can also elect to make certain information private so that it does not display on the screen when the user views the maintain my garage option 120. In the maintain my garage option 120, the user can further add and remove vehicles from the display so that the user can easily filter the profile. As shown in EX. 7B, the user can open the edit feature on the maintain my garage screen, and then the information about the particular vehicle can be edited/changed. Also, a vehicle 12 can be added as well as the add vehicle screen may be displayed to include additional information about another vehicle 12 to be included in the “maintain my garage.” The profile can also contain additional settings, including, but not limited to, battery setup, OBD/maintenance setup, summary report information, and a contact us where the user can contact the entity/company.

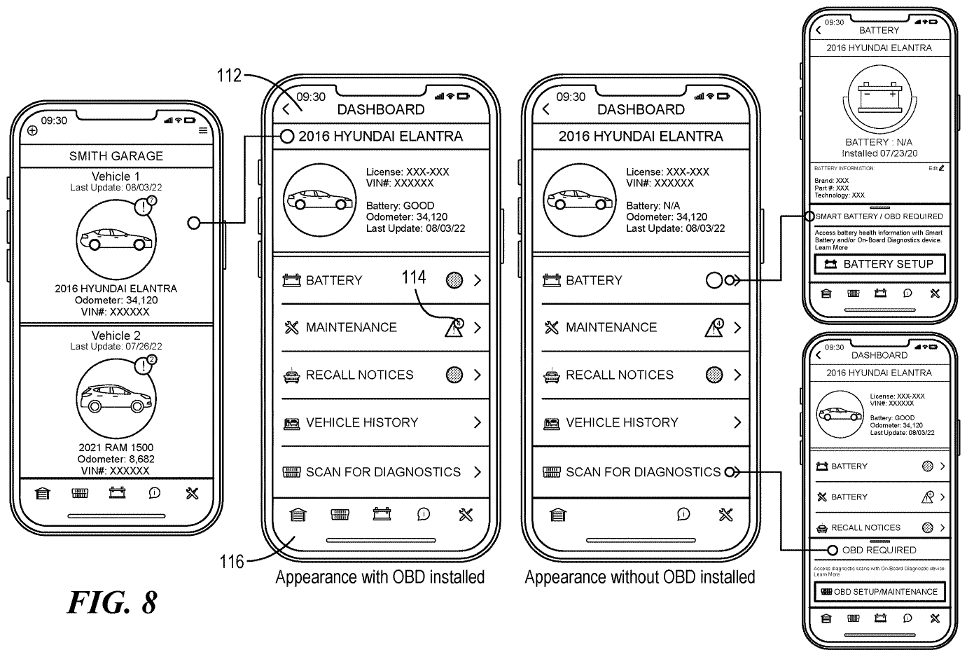

FIG. 8 is another exemplary embodiment of the display 112 with the dashboard pages based on having an OBD installed. When an OBD is installed, for example with the accessory 20, the system 10 can collect information about the vehicle 12, from the battery 14, the accessory 20, the server 28, and/or the device 24. With this information and data, the display 112 may include a wide variety of information related to the vehicle 12. For example, the display 112 may have information about the battery 14, maintenance actions which may include the maintenance action indicator 114, recall notices, vehicle history information, parameter and function information, and diagnostic scan information. The vehicle history, which may be an additional maintenance parameter, such as a historical parameter, may allow a user to review the data and information that has been collected about the individual vehicle which may include driving time, breaking data, speed, type of driving, the crank profile history, acceleration data, mileage, accidents, recalls, warranties, repair records, time in which the wipers are used, time in which the lights are activated, how many owners the vehicle has had, the timing of services and/or maintenance on the vehicle, as well as other historical vehicle information. The information and data that is gathered through the system 10 may be used to determine whether there should be a maintenance action as well as a maintenance action indicator 114 on the display 112. For example, at least one of the maintenance parameters may be combined at least one other of the maintenance parameters, and at least one function to determine whether any maintenance action is warranted and if a maintenance action is created then the display 112 may include the maintenance action indicator 114 which may have information about the maintenance parameter(s), and/or functions, and/or any additional information and data that was/were used to create the particular maintenance action. Also, the maintenance action indicator 114 may include what type of maintenance and/or further diagnostic work is recommended for the vehicle 12. The type of maintenance and/or diagnostic work that may be suggested may include any of the systems and/or components of the vehicle 12. Detailed information about the battery may be displayed if the user selects battery including the date that the battery 14 was installed in the vehicle 12, the brand, the part number, and specific technology information related to the battery 14. Also, the user may be able to select the scan for diagnostics option which may include the ability to access information from diagnostic scans on the vehicle 12.

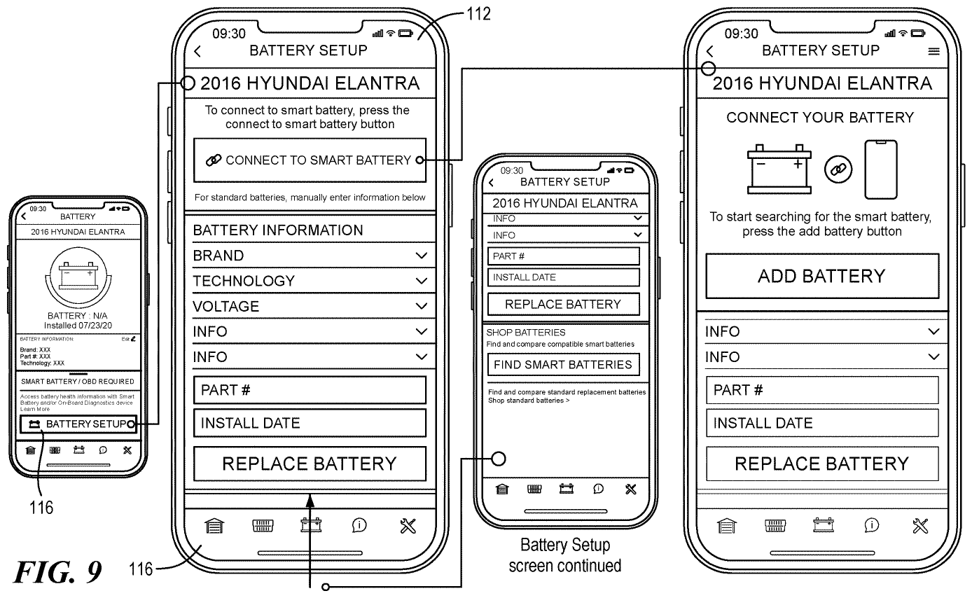

FIG. 9 shows example battery setup pages. On the display 112 one of the icons 116 may include an image of the battery 14. Information and data about the battery 14 that is used in the vehicle 12 can be inputted into the display 112. If the battery 14 is a smart battery, the information may be able to be automatically populated into the system 10 as well and does not need to be manually inputted. The user can select the smart battery and then connect/add the battery to the system 10. Alternatively, if the battery 14 is a standard battery that does not have smart technology capabilities, the information about the battery 14 may be manually entered using the display 112 or another component of the system 10. Some of the information that may be included can be information about the brand, the technology that is part of or used with the battery 14, the voltage, the part number, the installation date, and other relevant information for the battery 14. Also, customized battery 14 information may also be included in the display 112. The display 112 may include information about when to replace the battery 14 based on certain parameters and/or functions measured by the system 10. If there is a maintenance action suggesting that the battery be replaced, the system 10 may include information so that a user can shop for batteries and find and compare batteries that may be usable for the vehicle 12 as well as battery prices, battery availability, the batteries which are most suitable for the environment that the vehicle 12 is in, information about how particular batteries may impact the environment, and other relevant information. The user may also be able to actually purchase a battery that is viewed on the display 112 as well which will be compatible with the vehicle 12.

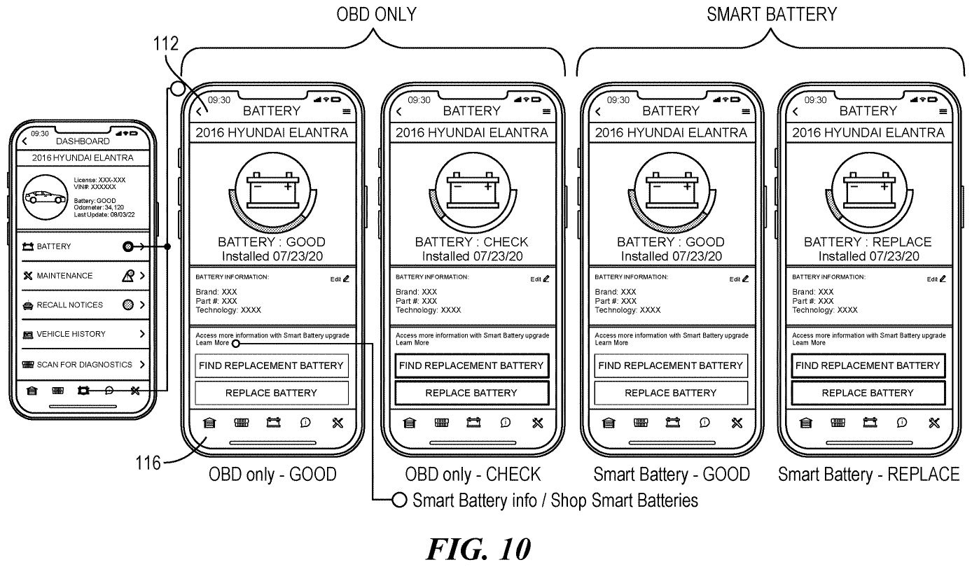

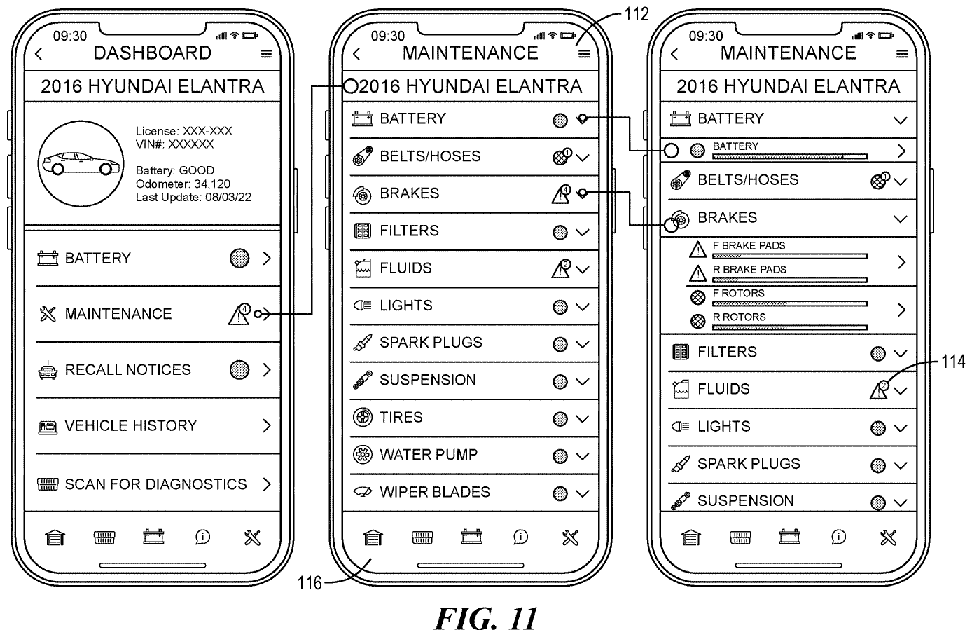

FIG. 10 shows another example battery screen where an OBD and/or smart battery is installed. In the exemplary embodiment as shown in FIG. 10, with the OBD or the smart battery connected to the system 10, there may be information about the battery 14 that is available on the display 112. For example, the battery information may include information about the brand, the part number, the technology used in the battery, the charge on the battery, as well as additional information that is available to the user about the battery 14. If a user clicks on the “learn more” feature or “additional information” or something similar, the user can access significantly more information and data about the particular battery 14. Further, depending upon the particular parameters that are detected using the system 10, the maintenance action may include a suggesting that it is time to replace the battery. Additionally or alternatively, the maintenance action may indicate that the battery is “good”, “fair”, “poor”, “check”, “replace” or a color coding system where green is good, yellow is caution, and red means that it is time to replace the battery. The battery screen health gauge options may include a gauge on the battery icon on the display 112 (e.g., gauge on bottom half of battery icon, gauge on top half of battery icon, respectively). The graphic display include various colors to make it easier to use and identify when some system or component in the vehicle 12 requires attention, maintenance, and/or repair. This determination that it may be time to replace the battery may be based on one particular parameter and function or more than one parameter and function. If the maintenance action suggests that the battery 14 should be replaced, the user may be able to connect to information to assist in finding a replacement battery as well.

FIG. 11 shows exemplary maintenance screens associated with certain parameters that are enabled when OBD and/or smart battery is installed. One or more parameters may indicate that an associated vehicle or battery item is in condition for replacement or maintenance based on a function, conduction, and/or parameter. For example, brake pads are shown as indicating attention, i.e., brake pads maintenance is required based on a predetermined a time range such as where thirty-four months have elapsed from the prior brake maintenance event, and the expected maintenance is recommended at or before thirty-six months. In some embodiments, the brake pads may be shown as being recommended for replacement based on another parameter associated with the vehicle 12 and/or battery 14. Another example includes where a parameter other than a parameter associated with the brakes (i.e., battery replacement period exceeded) is identified as requiring a visit to the service provider, device 24 may be configured to suggest a bundled service, i.e., the battery replacement and the brake pads replacement, based on one or more promotions, battery life cycle parameters, brake parameters, etc. as well as certain functions associated with the battery and/or brake pad. In other words, device 24 may be configured to determine a scheduled maintenance action based on the values of other parameters and/or functions such as to maintain a desired battery life cycle goal (e.g., warranty, continued product quality, goal associated with providing battery as a service, etc.) or vehicle condition goal. The maintenance action indicator 114 may include information about the battery, belts/hoses, brakes, filters, fluids, lights, spark plugs, suspension, tires, water pump, and the wiper blades as well. This is not meant as an exhaustive list as information about any system and/or component that is part of the vehicle 12 may be included as well. Also, information may be customized as certain vehicles may have specific systems and/or components that are not found on other vehicles.

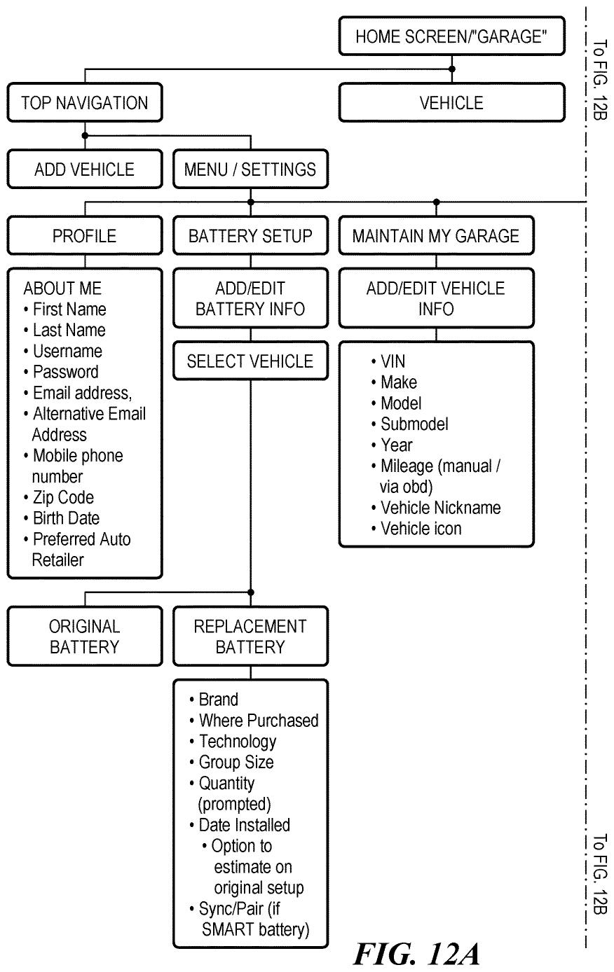

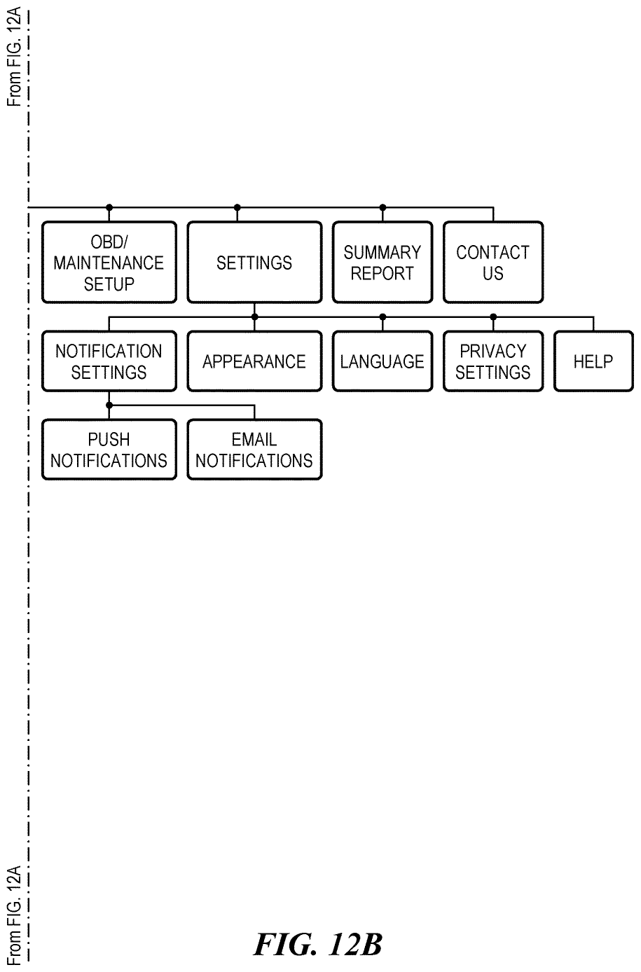

FIGS. 12A and 12B show an exemplary screen navigation structure. FIG. 12 A shows a first portion of the exemplary screen navigation structure and FIG. 12B shows a second portion of the exemplary screen navigation structure from FIG. 12A. It will be understood that FIGS. 12A and 12B may be combined to form a single exemplary screen navigation structure but are being shown in two separate portions through FIGS. 12A-12B. In this nonlimiting example, as shown in FIG. 12A, the home screen provides screen navigation controls to navigate to a top navigation screen and a vehicle screen. Each screen may further provide navigation controls to other screens such as screens to add and/or remove a vehicle and providing menu/settings. The exemplary screen navigation structure may include a profile which may include information about me including a first name, last name, username, password, email address, alternative email address, mobile phone number, zip code, birth date, and preferred auto retailer. Additional screens associated with menu/settings are shown in FIGS. 12A and 12B, e.g., profile, battery setup, maintain my garage, OBD/maintenance setup, settings, summary report, contact screen, etc. Additional navigation may be configured to access other screens associated with each of these components. As one example, in the battery setup screen, a user may add/edit battery information, select a vehicle and then view information related to the original battery and/or the replacement battery. Information about the replacement battery may include the brand, where it was purchased, warranty information, the technology, the group size, the quantity, the date it was installed, syncing/synchronizing or pairing the battery with a device, and optional additional information as well. This optional information may include, but is not limited to, customized information about the battery including reminders and other battery information that the user would like to input into the system 10. In another setting option as shown in FIG. 12A, there may be the “maintain my garage” option and the user may add/edit vehicle information. For example, this vehicle information may include the VIN number, make, model, submodel, year, milage (which may be input manually or read from the OBD), the vehicle nickname, and the vehicle icon, as well as other related information. This information may also be customized as well. The menu/settings may also include, as shown in FIG. 12B, the OBD/Maintenance setup, Settings, Summary Report and Contact us. In this exemplary embodiment, the Settings may include notification settings including push notifications and email notifications, appearance, language, privacy settings, and help.

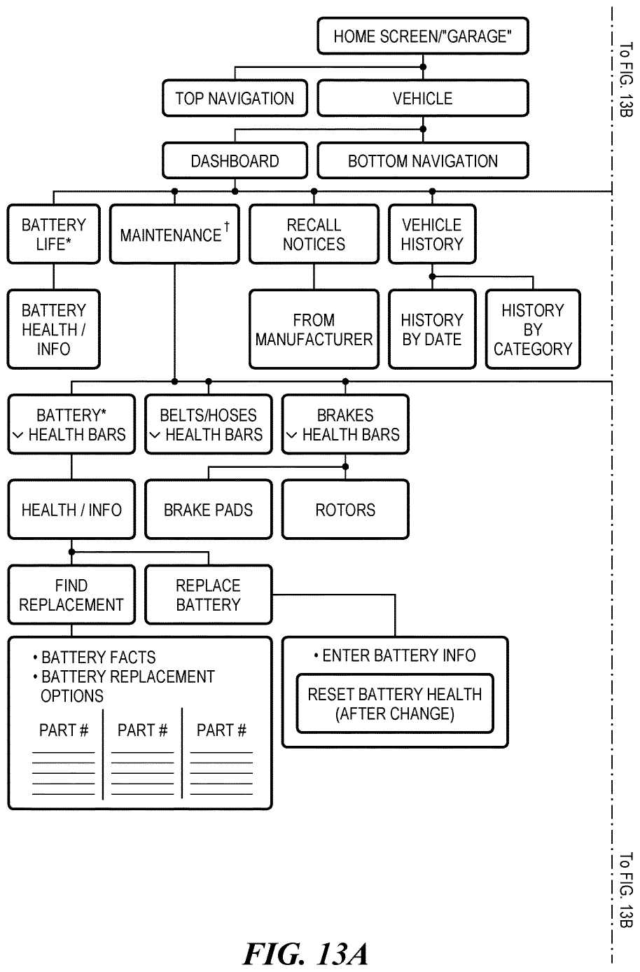

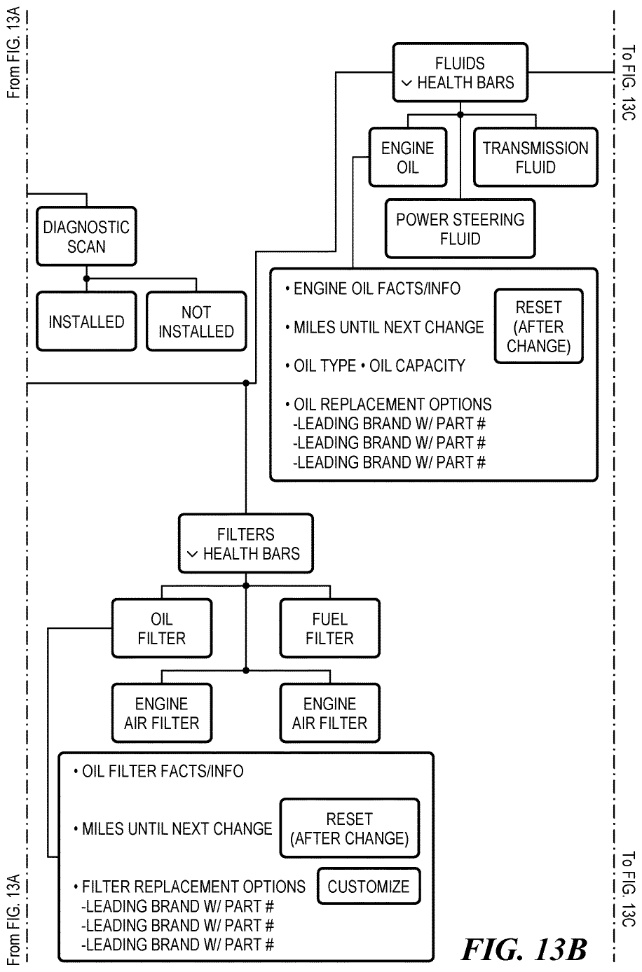

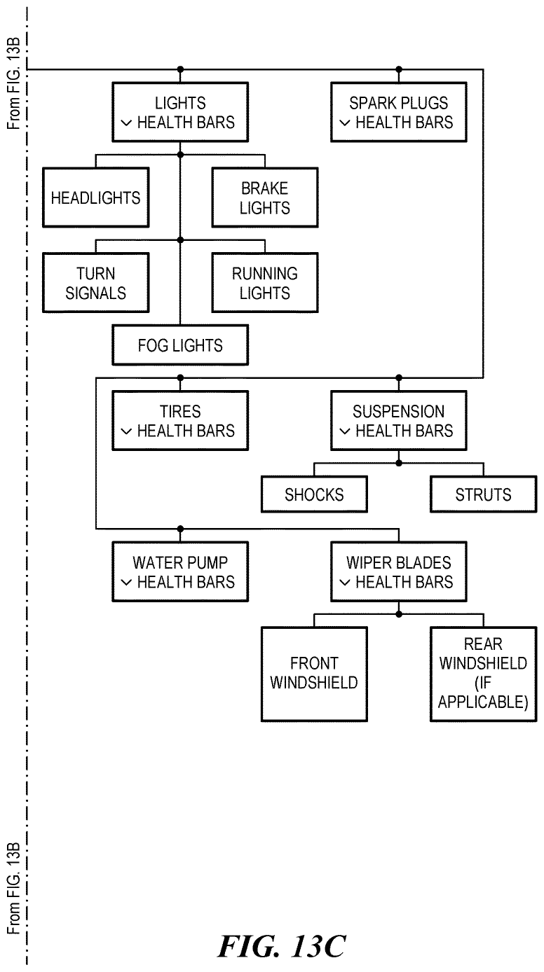

FIGS. 13A-C shows another exemplary embodiment of a navigation screen associated with the vehicle showing the exemplary embodiment in a first portion, a second portion, and a third portion, e.g., the home screen, vehicle, dashboard, bottom navigation, etc. It will be understood that FIGS. 13A, 13B, and 13C may be combined to form a single exemplary screen navigation structure but are being shown in three separate portions through FIGS. 13A-13C. As shown in FIG. 13A, the user can navigate to the home screen/garage and then select the particular vehicle that is of interest and view information in the dashboard for that vehicle. In reviewing the maintenance information, this information may include information about the battery 14 which includes the battery life, the battery health, and other information as well. Also, the maintenance information may include information about battery health bars, the belts/hoses and health bars, and the brakes and associated health bars. The “health bars” indicate the health status of a particular component and/or system of vehicle 12. In reviewing the maintenance informational and the battery health bars as well as the health information related to the battery, if a replacement battery is suggested, then there may be information about potential battery replacements including facts about the various batteries and potential replacement options that may be available. Information that allows the user to compare various potential replacement option batteries may help the user select what battery will be best suited for the vehicle, the particular environment, the type of driving done on the vehicle. Further details about replacement batteries may include information about the part numbers associated with particular replacement batteries. Once a replacement battery is selected, the user can input the data about the battery and other customized information as well. For example, if the battery is in a cold environment the parameters for the battery may be different than a battery that is in a very environment as all this can significantly impact the life of the battery and when the battery may require replacement. Further, on the “ENTER BATTERY INFO” screen, the user may be prompted to reset battery health such as after change of a battery is performed. In some embodiments, this action may be automated by receiving information from the BMS that the battery is a replacement battery.

Continuing to refer to FIGS. 13A-13C, in reference to the maintenance bar, there may be a health bar to provide the status of the health of the belts/hoses, the brakes, the filters, the fluids, the lights, the spark plugs, the suspension, the tires, the water pump, and the wiper blades. Each of these maintenance areas provides the user with additional information about the vehicle 12. As a non-limiting example, the brakes can include information about the brake pads and rotors. The filers can have information about the oil filter including oil filter facts and information, miles until the next change, along with filter replacement options and certain brands with part numbers. Once the oil filter is changed, the miles until the next change can be reset and/or customized. For example, if the user is in a warm or cool climate this may impact how frequently the oil filters should be changed in the vehicle. Additional information and details may be provided about engine air filters, cabin air filters, and fuel filters. The fluid health bar may have information about the engine oil, the power steering fluid, and the transmission fluid. With respect to the engine oil there may be additional information about facts and information related to the oil, the milage until the next change, the oil type and/or capacity, and the oil replacement options including certain brands and affiliated numbers with the particular products. Also, once the engine oil is changed, the miles until the next change can be reset and/or manually adjusted. For example, if there is a reason that the engine oil should be changed sooner or later than the general recommendation, this can be set manually. With the lights, there may be a light health bar which may have information about the headlights, the brake lights, turn signals, running lights, hazard/fog lights, and any other lights associated with vehicle 12. There may be a spark plugs health bar with information about the health and any associated condition with any spark plugs associated with vehicle 12. There may be a tires health bar with information about the health and any associated condition with any tire associated with vehicle 12. Also, if the tires are in a warm or cool climate and/or the tires are used for frequent off-roading and other usage that may impact the tires, this can be incorporated into the information about the health of the tires of vehicle 12. The suspension may have health bars and include information related to shocks and struts for the suspension. There may be a water pump health bar with information about the health and any associated condition with the water pump associated with vehicle 12. Furthermore, the wiper blades may have health bar information which may include information about the front windshield as well as the back windshield if a back windshield exists. It will be understood that these are meant as non-limiting examples of options that may be available on the maintenance bar. There may also be information related to battery life, recall notices (including notices from the manufacturer), vehicle history (history by date and history by category). In addition to detailed maintenance information, the navigation screen, as shown in FIG. 13A may include recall notices from the manufacturers related to any part and/or system of vehicle 12, the vehicle history including the history of the vehicle by date and the history of vehicle 12 by category which can provide detailed historical information about vehicle 12 including when tires were placed on vehicle 12, when any and/or all tires were replaced on vehicle 12, any repairs related to vehicle, any original and/or replacement components and/or systems on vehicle as well as other information about the history of the parts and components of vehicle 12. Finally the navigation screen may include diagnostic scan information including whether the diagnostic scan has been installed on the vehicle or not installed on the vehicle.

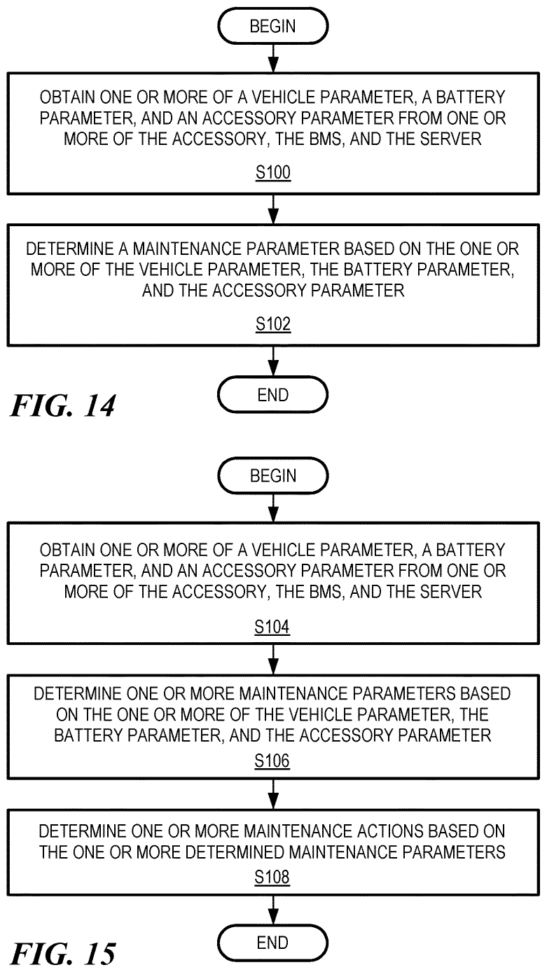

FIG. 14 is a flowchart of an example process (i.e., method) in device 24 according to some embodiments of the present invention. One or more blocks described herein may be performed by one or more elements of device 24 such as by one or more of processing circuitry 74 (including the device management unit 26), processor 76, and/or communication interface 72. Device 24 is configured to obtain (Block S100) one or more of a vehicle parameter, a battery parameter, and an accessory parameter from one or more of the accessory 20, the BMS 16, and the server 28. Device 24 is further configured to determine (Block S102) a maintenance parameter based on the one or more of the vehicle parameter, the battery parameter, and the accessory parameter.

Now referring to FIG. 15 is another exemplary flow chart of an example process (i.e., method) in device 24 according to some embodiments of the present invention. One or more blocks described herein may be performed by one or more elements of device 24 such as by one or more of processing circuitry 74 (including the device management unit 26), processor 76, and/or communication interface 72. Device 24 is configured to obtain (Block S104) one or more of a vehicle parameter received from one of the accessory and the server, a battery parameter received from one of the BMS 16 and the accessory 20, and an accessory parameter from one or more of the accessory 20, the BMS 16, and the server 28. Device 24 is configured to determine (Block S106) one or more maintenance parameters based on the one or more of the vehicle parameter, the battery parameter, and the accessory parameter. Device 24 is further configured to determine (Block S108) one or more maintenance actions based on the one or more determined maintenance parameters.

In some embodiments, the method further includes assigning a rank to each one of the vehicle parameter, the battery parameter, and the accessory parameter.

In some other embodiments, the rank is based on one or more of a predetermined battery life cycle, a battery parameter threshold, a service promotion, a maintenance schedule, an alert, and a recall.

In some embodiments, the method further includes identifying a preset battery function and a preset vehicle parameter and triggering the one or more maintenance actions based on the preset battery function and the preset vehicle parameter, the one or more maintenance actions indicates a battery replacement.

In some embodiments, the method further includes identifying a preset battery parameter and triggering the one or more maintenance actions based on the preset battery parameter, the one or more maintenance actions indicates a replacement of at least one brake pad.

In some other embodiments, the method further includes identifying a preset vehicle parameter for a vehicle alternator and triggering one maintenance action of the one or more maintenance actions based on the preset vehicle parameter, the one maintenance action indicating a remaining life cycle of the battery 14.

In some embodiments, any component of system 10 such as device 24 may be configured to predict a life cycle of the battery based on one or more parameters and/or functions not associated with the battery 14 or not directly associated with the life cycle of the battery 14. For example, prediction of lifecycle of the battery 14 or other components of system 10 may be performed based on a parameter associated with another area of data collection, e.g., predicting life cycle of the battery based on a parameter associated with a vehicle alternator as well as function information including the environment where the vehicle is driven, how the vehicle is driven, and other functional information related to the vehicle 12 as well.

In some other embodiments, when software 80 (e.g., mobile application) is started, device 24 wirelessly connects to BMS 16 such as via Bluetooth or another suitable wireless communication protocol. Device 24 may then receive data associated with battery 14. The data may be shown in one or more displays 112 having one or more navigation structures described above. Additional data may be received from an accessory 20 such as an OBD connected to vehicle 12 and configured to monitor one or more vehicle parameters and/or functions, which may be transmitted to device 24 (e.g., to be displayed by software 80). Parameters shown by software 80 may be customizable such as to adjust scheduling of the vehicle maintenance based on a specification of one or more parts associated with vehicle 12 (e.g., brake pads). For example, when brake pads installed on a vehicle 12 require maintenance at a frequency different than recommended maintenance schedule for (original equipment manufacturer) OEM brake pads, a user of the software 80 may customize the brake pads replacement frequency parameter. OEM maintenance schedules may be downloadable from server 28 (e.g., OEM server). For example, device 24 may be configured to download data using vehicle information, e.g., VIN, and/or battery information. Intervals for the parts, components and/or systems associated with the vehicle information and/or battery information may be comprised in the downloaded data. The data may be downloaded from server 28 (e.g., having default OEM schedules) and/or from any other device. In some embodiments, the downloaded data includes default intervals. The default intervals may be customized by a user (e.g., of software 80) such as based on the particular parts being used or other parameters that may be customized.

In some embodiments, device 24 may be configured to determine one or more functions (e.g., shown on software 80, on the dashboard, etc.) based on whether accessory 20 (e.g., OBD) is connected to vehicle 12 and/or battery 14 and/or device 24 and/or server 28. These functions may include but are not limited to battery functions, accessory functions, vehicle functions, device functions, and server functions. That is, in some embodiments, software 80 may be configured to provide one or more functions associated with any of the components or systems of system 10 on a single user interface, thereby connecting all the information and data together in one place for a user.

In some other embodiments, battery 14 is provided as a battery as a service in which the user of the battery does not own battery, but rather has the right to use the battery in a prescribed manner. The battery 14 will be replaced by the battery as a service provider when required. One or more parameters may be modified, or an indication triggered based on a life cycle requirement, the functioning of the battery as determined by the system 10, and/or the set schedule for replacement that is provided by the battery as a service provider. For example, where a battery is in a degraded condition and this function becomes apparent by the system 10, an event triggered or parameter may be modified such that a user of battery 14 receives a maintenance action which then may trigger a maintenance action indicator 114, e.g., via software 80, indicating a battery maintenance visit has been scheduled based on the degraded condition. The life cycle requirement may comprise an SoC level below a predetermined threshold that may potentially cause a catastrophic failure of battery 14, i.e., that shortens the life of the battery 14 if the SoC condition is maintained for a predetermined period of time. Accordingly, if this function is measured in the SoC and compared with particular parameters, a maintenance action may be triggered.

In some embodiments, accessory 20 (e.g., OBD) is configured to obtain one or more parameters and functions associated with battery 14 (e.g., smart battery via BMS, battery via a sensor associated with the battery) as well. For example, accessory 20 may be configured to obtain SoC information or other information about the battery 14, e.g., determined by BMS 16. Based on the obtained information from accessory 20, battery failure may be anticipated to occur within a time interval. The information obtained from accessory 20 may also be combined with information from the battery 14 to determine the state of health of the battery 14. Conventional OBD devices are unable to obtain battery information.

Further, one or more components of system 10 such as BMS 16 and/or accessory 20 and/or device 24 may be configured to determine a crank wave profile (e.g., associated with the cranking of an engine). A voltage profile associated with the crank wave profile may be used to predict a battery failure. In a nonlimiting example, a voltage variation such as a voltage drop as a measured function compared to a predetermined voltage threshold as a preset parameter may be used to predict the battery failure. The predicted battery failure may be communicated to any component of system such as device 24.

In some embodiments, battery failure may be predicted, or a parameter may be modified based on a plurality of functions, where the functions may have a different hierarchical rank. For example, a hierarchy of functions may include a function such as change in SoC greater than a predetermined threshold and air conditioner filter needing replacement within the next six months. In this nonlimiting example, the rank of the change of SoC is greater than the rank of the air conditioner filter. Device 24 may be configured to accelerate the schedule battery maintenance and/or bundle it with the air conditioner (i.e., recommend both to be performed in a single visit to a service provider). Bundling may be performed based on other parameters and/or conditions such as promotions. In some embodiments, maintenance associated with the air conditioner to have a lower rank (e.g., a lower priority) than the rank of the change of SoC such that replacement of the air filter is not bundled. That is, device 24 may be configured to change OEM recommended schedules or any other schedules based on other parameters and/or functions associated with the vehicle 12 and/or battery 14. In one or more embodiments, maintenance may be automatically scheduled by device 24 (and/or server 28) based on information obtained by accessory 20 and/or BMS 16.

In some embodiments, the determination made by device 24 to indicate that vehicle 12 should be taken to service provider for maintenance may depend on more than one parameter and/or function that indicates attention is needed (and/or other items not indicating as such). In some other embodiments, instead of the individual items driving individual maintenance visits, device 24 may be configured to holistically determine maintenance scheduling based on a plurality of parameters and/or functions some of which may not otherwise require a maintenance visit. In some embodiments, the determination is made to provide maintenance that is as undisruptive to the customer as possible.

In some embodiments, Server 28 may be able to access, accumulate, and synthesize information including but not limited to historical data and real-time data from any other device, including but not limited to data about and relating to the vehicle 12, battery 14, accessory 20, historical data about the vehicle/system/or component, and/or device 24 that is in communication with the server 28 and use this data and information alone or in conjunction with additional information/data including but not limited to battery function, accessory function, BMS function, device function, and/or server function to provide a maintenance parameter. As a non-limiting example, server 28 may be configured to access information from various devices and based on the information provided to server 28, server 28 may provide a maintenance parameter to device 24 to assist in determining a course of action including but not limited to a proposed maintenance action. The server 28 may be provided historical data indicating, for example, the average time that a particular vehicle may need its brake pads replaced, mileage information, environmental information, which may be based in part upon historical data for the particular make and model of the vehicle. The server 28 may also be in communication with other devices in vehicle 12 including the accessory 20 which may have parameters and functions related the vehicle 12, battery 14, the BMS 16, the accessory 20, and/or the device 24 as well as other information and data which may be merged and/or aggregated with the historical information by the server 28 and the server 28 may determine a maintenance action based on this information. The information related to the maintenance action may relate to a maintenance, diagnostic matters and/or upkeep of the vehicle including any system and/or component of the vehicle. For example, depending upon the battery 14, accessory 20, vehicle 12, and other device parameters and functions, certain maintenance actions may be determined. For example, depending upon the parameters, functions, and other information and/or data provided, an example of a maintenance action may be that the brake pads should be replaced on the vehicle 12. By way of example, the server 28 may have information about the battery life of a particular battery based on the make and model of the specific battery in the vehicle 12, various environmental conditions that may impact the battery, how the vehicle 12 is driven, how often the vehicle 12 is turned on and off, any customization of the vehicle 12 as well as other information and data. The server 28 may also be in communication with other devices in vehicle 12 including the accessory 20 (which may include the OBD) and the BMS 16, and the battery 14 as well as external devices, and the server 28 may aggregate the information and the server 28 may provide one or more maintenance actions based on this information about when it may be time to replace the battery in the vehicle 12.

In some embodiments, one or both of the vehicle parameter and function and the battery parameter and function is received from and obtained by the accessory 20 from the BMS 16.

In some other embodiments, the vehicle parameter is received at least in part from the server 28.

In an embodiment, one or both of the vehicle parameter and the battery parameter includes one or more OEM maintenance schedules.

In another embodiment, the one or more OEM maintenance schedules are user customizable based on one or both of vehicle information (e.g., specification of parts installed other than OEM parts) and battery information (e.g., information associated battery service).

In another embodiment, the one or more OEM maintenance schedules are user customizable based on one or both of vehicle functions and battery functions.

In some embodiments, determining the maintenance parameter is based on a rank associated with one or more of the vehicle parameter, the battery parameter, and the accessory parameter.

In some other embodiments, the rank is assigned to each one of the vehicle parameter, the battery parameter, and the accessory parameter based on one or more predetermined battery life cycle, a battery parameter threshold, a service promotion, a maintenance schedule, an alert, and a recall, and function of a particular system and/or component of the vehicle 12.

In an embodiment, the maintenance parameter includes a suggested time for a service visit (e.g., within the next three days) and a priority level (e.g., high priority) associated with the one or more of the vehicle parameter, the battery parameter, and the accessory parameter.

In another embodiment, the service visit indicates a battery replacement.

In one or more embodiments, accessory 20 (e.g., OBD II) and/or a BMS 16 of a smart battery 14 may be configured to connect to a device 24 (e.g., consumer phone) via one or more communication links using one or more protocols such as Bluetooth. In one or more embodiments, software 80 (e.g., a software application) may be configured to cause transmission (e.g., via communication interface 72) of one or more parameters such as battery state of charge and/or vehicle information including mileage to a server 28 (e.g., cloud server). The transmission of the one or more parameters may be performed via device 24 (e.g., consumer phone). Server 28 may be configured to provide a state of health assessment of the battery 14. In some other embodiments, software 80 (e.g., software application) and/or device management unit 26 may be configured to compare mileage (or time) to the vehicle manufacturers recommended maintenance intervals to provide a recommendation for replacing parts on the vehicle 12 (e.g., wipers, filters, brakes, etc.). In some embodiments, replacement purchases can be grouped together and linked to retail partners. In addition, based on the consumer location, the application will guide consumers to a nearest retail outlet.

Also, for example, the server management unit 30 may be configured to retrieve information stored on the server 28 and share information with the server 28 as well. If the server 28 is enabled, the server 28 may be programmed to share information about the vehicle 12 and/or retrieve information about the make/model of the vehicle 12 or particular information about the vehicle 12 including the operation history of the vehicle including any recalls on the vehicle, acceleration, deceleration, rates of speed, any periods of storage, the surrounding environment for the vehicle, where the vehicle is parked, surrounding salt and/or fresh water, precipitation etc. The server management unit 30 may have information including the maintenance schedule relating to certain systems in the vehicle 12. For example, the server management unit 30 may have information from the manufacturer about specific maintenance expectations/requirements which are provided by the manufacturer which can be integrated into the system 10 and used to determine if a maintenance action may be warranted. Additionally, the server management unit 30 can communicate with the server 28.

In one or more embodiments, unplanned downtime due to battery or maintenance item failures can be avoided as device 24 can be configured to predict one or more elements associated with battery lifecycle and maintenance. In some embodiments, the prediction may include determining and/or suggesting scheduling of maintenance items at a time that is different than predetermined schedule. In some other embodiments, the time is different than a predetermined schedule suggested by an OEM, e.g., where the user is provided with a customizable schedule based on one or more priority factors. In an embodiment, prediction is performed using artificial intelligence, machine learning, etc.

In some embodiments, scheduling maintenance or a part purchase may be performed in advance of a failure of the part. In some other embodiments, a consumer or user may be able to track and take action on vehicle maintenance items for all vehicles in single platform. In an embodiment, the consumer or user may monitor battery health on the device 24 (e.g., mobile phone). In another embodiment, purchases for battery and maintenance items may be linked and grouped together for purchase.

In some embodiments, battery 14 may be configured to communicate its performance and/or when it needs to be replaced. In some other embodiments, device 24 and/or server 28 may be configured to predict the battery state of health, which may provide for planned replacement, utilize full life of battery 14, prevent unplanned failures of battery 14, etc. In some other embodiments, the vehicle's performance may be optimized as one or more components of system 10 provides a full understanding of the battery capability. In some embodiments, understanding battery status (e.g., charge) enables OEMs to optimize performance of the vehicle (such as fuel consumption, emissions, performance) which may improve consumer experience.

In some embodiments, battery 14 and battery health prediction may be provided as a service, where dashboards and/or mobile applications such as software 80 may be provided such as via one or more communication links and/or a cloud platform, network, and/or one or more communication interfaces. In some other embodiments, battery 14 may be a smart battery or a battery having at least one sensor for determining one or more parameters. In one or more embodiments, predictive analysis and/or trend data may be provided.

In one or more embodiments, a device 24 (e.g., having software 80 such a software application) and/or accessory 20 (e.g., OBD II) may be provided. In some embodiments, access to the software application (i.e., software 80) and/or data may be provided, e.g., even without a connection to vehicle 12. In some other embodiments, data collection, e.g., without a connection to vehicle 12, may be provided. In an embodiment, one or more of the following may be provided: a maintenance scheduler function, maintenance alerts, replacement parts identification, link to retail site, link to retail rewards program, battery diagnostics, battery maintenance alerts with recommended actions, vehicle diagnostics scan (e.g., of error codes), clear or reset fault codes, trip information (milage, speed, fuel economy), recall notices, historical report, email reports, etc. In another embodiment, battery diagnostics may comprise internal combustion engine information such as start and stop information, and mild-hybrid information. In some embodiments, battery diagnostics may include battery alerts and planned replacement information.

In some embodiments, the maintenance scheduler function may be customizable, adjustable, actionable, etc. In some other embodiments, battery diagnostics may include real-time state of health, state of fault, state of charge information. In an embodiment, historical reports and or trip information may be manually provided.

In one or more embodiments, software 80 (e.g., a software application) has a home screen (e.g., on device 24) which may include information of one or more vehicles (e.g., garage). The home screen may be a user interface and be accessible with or without connection to one or more devices. In some embodiments, software 80 may refer to a main landing spot such as for the user and may include icons at various locations on the user interface (e.g., bottom or top of all screens). Information provided by software 80 may comprise a dashboard, scan (OBD II), maintenance information, an advance home page, vehicle history, battery health information. In some embodiments, a dashboard is provided and may include alerts, recalls, key maintenance items, battery health information. The information on the dashboard may be color coded, e.g., red/yellow/green for each key area (e.g., green—good to next maintenance check, yellow—need to monitor, red—need immediate attention). Further, the information may be configured to provide access to error codes such as a link to a server or third party entity that can provide error code details, recall notices such as link to National Highway Traffic Safety Administration (NHTSA) such as via OBD II or manual vehicle identification number (VIN) entry. Further, the dashboard may be configured to provide maintenance alerts such as link to maintenance item detail and a web site for purchased parts and instructions.

In some embodiments, accessory 20 (e.g., OBD II) may be configured to provide a scan such as a full system scan for Error Codes (e.g., using OBD II Only). Each area with links to access details may be provided. Further, error codes may be provided via a link to a server or third party entity that can provide error code details (e.g., using OBD II Only) and/or recall notices may be provided via link to NHTSA (OBD II or manual VIN entry). In some other embodiments, maintenance information such as a start with recommendations. In an embodiment, maintenance may be customized. In an embodiment, each line of the maintenance information may be actionable. In another embodiment, a red/yellow/green for each key area is provided. Each line item may have a baseline set by manufacturer recommended setting for vehicle, and then allow for manual adjustments. In some embodiments, clicking through on each item is enabled and a link to a site for purchased parts and instructions is provided, e.g., when using accessory 20 and/or battery diagnostics and maintenance scheduling.

In an embodiment, accessory 20 (e.g., OBD II dongle) may be programmable and configured to communicate with other devices using one or more protocols such as Bluetooth. Accessory 20 may provide battery diagnostics and vehicle diagnostics and be configured for data storage. Further, accessory 20 may be configured to communicate using other protocols or radio access technologies. In another embodiment, accessory 20 may be configured to provide one or more of the following data outputs: battery SoH, vehicle error codes, vehicle recall summary, global positioning system (GPS) data and/or speed, idle and/or start-stop time, tire pressure, etc.

In some embodiments, accessory 20 may be configured to communicate with device 24 (consumer mobile device) which may be configured to communicate with server 28 (e.g., on a cloud network) and/or provide data and/or information usable for an application or web portal (e.g., software 80) on device 24.

Example information which may be provided via software 80 of device 24 may include log maintenance for all vehicles may be provided information may include maintenance scheduling and setting automated maintenance reminders. Vehicle maintenance groupings may be used to facilitate improved scheduling. Information may be customizable and may further include savings on purchased parts such as discount for bundled orders, time to capitalize on promotions. Further, software 80 may be configured as a “one-stop shopping” for maintenance and provide access to vehicle maintenance, replacement error code information (including installation instructions and videos), accurate assessment of vehicle health in real-time, advanced failure detection and notification such as to avoid getting stranded.

In some embodiments, users of system 10 (e.g., service providers) may receive battery replacement information, direct connection to rewards programs, access to higher fidelity data on the consumer, including driving behavior and true maintenance needs. Further, users may be able to target, plan, and bundle promotions based on vehicle maintenance needs and improved customer insights. The promotions may be used by device 24 to determine one or more actions associated with life cycle of battery 14 and/or vehicle 12. Further, warranty actions may be based on battery SoH accuracy.

In some other embodiments, users of system 10 (e.g., battery manufacturer) may receive access to high fidelity data, consumer data (driving patterns, maintenance & purchase behavior), VIN level vehicle information including fault codes and component issues, battery level information, consumer behavior, etc. Information received by the user may be further used to determine demand forecast-planned inventory based on actual customer needs and warranty information based on battery SoH accuracy.

In some embodiments, device 24 and/or processing circuitry 74 may be configured to generate a maintenance action indicator. The maintenance action indicator may be used for notification of a user of any components of system 10 and/or cause any component of system 10 to perform another action. For example, the maintenance action indicator may notify a user of maintenance actions such that the user may act accordingly. The maintenance action indicator may also cause the BMS 16, the accessory 20, the server 28, and/or a vehicle system of vehicle 12 to perform another action, e.g., device 24 may communicate with the vehicle system via Bluetooth or any other protocol and cause the vehicle system to perform the other action.

The maintenance action indicator 114 may be included in a message transmitted by device 24 to one or more of the accessory, the BMS, the server, and a vehicle system, e.g., using any communication protocol. The maintenance action indicator may also cause device 24 to display an alert for the user on device 24, e.g., on a software application associated with software 80. The other action may also include one or both of scheduling a maintenance appointment (e.g., at a dealership or service center) and creating a record accessible by a service provider (e.g., by an agent of the dealership or service center). The record may indicate or include the maintenance actions. Further, the other action may cause the BMS to switch to a predetermined operating mode (e.g., a power saving operating mode, an operating mode that can meet a battery performance requirement, etc.).

The other action may also cause the vehicle system of vehicle 12 to display another alert (on a display on the dashboard, on an infotainment display, etc.). The vehicle system may also disable or enable a driving mode. For example, a driving mode that would minimize and/or disable the use of a predetermined component and/or system of the vehicle 12. A sports mode (e.g., where gears switch at higher revolutions per minute) may be disabled. Any other actions may also be performed.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings and the following embodiments.

1. A device configured to communicate with one or more of an accessory a battery management system BMS, and a server the device comprising processing circuitry configured to:
obtain one or more of a vehicle parameter, a battery parameter, and an accessory parameter from one or more of the accessory the BMS and the server
determine one or more maintenance parameters based on the one or more of the vehicle parameter, the battery parameter, and the accessory parameter; and
determine one or more maintenance actions based on the one or more determined maintenance parameters.

2. The device of claim 1, wherein one or more of:
the vehicle parameter is received from one or both of the accessory and the server the battery parameter is received from the BMS;
the battery parameter is received from the accessory; and
one or both of the vehicle parameter and the battery parameter is received from the BMS via the accessory.

3.-5. (canceled)

6. The device of claim 1, wherein one or both of the vehicle parameter and the battery parameter includes one or more original equipment manufacturer, OEM, maintenance schedules.

7. The device of claim 6, wherein the one or more OEM maintenance schedules are user customizable based on one or more of the vehicle parameter, the battery parameter, and the accessory parameter.

8. The device claim 6, wherein the vehicle parameter is one or more of vehicle spark plug performance, spark plug operation, and spark plug maintenance.

9. The device of claim 6, wherein the battery parameter is one or more of battery performance, battery management, battery operation, battery maintenance, and battery health.

10. The device of claim 1, wherein the processing circuitry is further configured to:
assign a rank to each one of the vehicle parameter, the battery parameter, and the accessory parameter, wherein the rank is based on one or more of a predetermined battery life cycle, a battery parameter threshold, a service promotion, a maintenance schedule, an alert, and a recall.

11. (canceled)

12. The device of claim 1, wherein the one or more determined maintenance parameters include a suggested time for a service visit and a priority level associated with the one or more of the vehicle parameter, the battery parameter, and the accessory parameter.

13. The device of claim 12, wherein the one or more determined maintenance actions indicates a battery replacement, and wherein the one or more determined maintenance actions further indicates at least one location to purchase a battery.

14. (canceled)

15. The device of claim 12, wherein the processing circuitry is further configured to:
identify a preset battery function and a preset vehicle parameter; and
trigger the one or more determined maintenance actions based on the preset battery function and the preset vehicle parameter, the one or more determined maintenance actions indicates a battery replacement.

16. The device of claim 1, wherein the processing circuitry is further configured to:
identify a preset battery parameter; and
trigger the one or more determined maintenance actions based on the preset battery parameter, the one or more determined maintenance actions indicates a replacement of at least one brake pad.

17. The device of claim 1, wherein the one or more determined maintenance actions includes at least two vehicle maintenance services.

18. The device of claim 1, where the processing circuitry is further configured to:
identify a preset vehicle parameter for a vehicle alternator; and
trigger one maintenance action of the one or more determined maintenance actions based on the preset vehicle parameter, the one or more determined maintenance actions indicating a remaining life cycle of a battery

19. The device claim 1, wherein the processing circuitry is configured to download one or more maintenance schedules from the server.

20. The device of claim 1, wherein one or more of:
the processing circuitry is further configured to generate a maintenance action indicator
the maintenance action indicator being one or more of:
notifying a user of the one or more determined maintenance actions
causing one or more of the accessory the BMS the server and a vehicle system to perform another action;
being included in a message transmitted by the device to one or more of the accessory the BMS the server and a vehicle system
causing the device to display an alert for the user on the device
the other action including one or both of scheduling a maintenance appointment and creating a record accessible by a service provider, the record indicating the one or more determined maintenance actions;
the other action including causing the BMS to switch to a predetermined operating mode; and
the other action including causing the vehicle system to one or both of:
display another alert; and
disable or enable a driving mode.

21. A device configured to communicate with one or more of an accessory a battery management system BMS, and a server the device comprising processing circuitry configured to:
obtain one or more of:
a vehicle parameter received from one of the accessory and the server
a battery parameter received from one of the BMS and the accessory and
an accessory parameter received from one or more of the accessory the BMS and the server
obtain one or more of:
a vehicle function received from one of the accessory and the server
a battery function received from one of the BMS and the accessory and
an accessory function received from one or more of the accessory (20), the BMS and the server
determine one or more maintenance parameters based on:
the one or more of the vehicle parameter, the battery parameter, and the accessory parameter; and
the one or more vehicle function, battery function, and accessory function; and
determine one or more maintenance actions based on the one or more determined maintenance parameters.

22. The device of claim 21, wherein one or both of the vehicle parameter and the battery parameter includes one or more original equipment manufacturer, OEM, maintenance schedules, wherein the one or more OEM maintenance schedules are user customizable based on one or both of the vehicle parameter and the battery parameter.

23.-25. (canceled)

26. The device of claim 21, wherein the processing circuitry is further configured to:
assign a rank to each one of the vehicle parameter, the battery parameter, and the accessory parameter, wherein the rank is based on one or more predetermined battery life cycle, a battery parameter threshold, a service promotion, a maintenance schedule, an alert, and a recall.

27.-31. (canceled)

32. The device of claim 21, wherein one or more of:
the processing circuitry is further configured to generate a maintenance action indicator
the maintenance action indicator one or more of:
notifying a user of the one or more maintenance actions;
causing one or more of the accessory the BMS the server and a vehicle system to perform another action;
being included in a message transmitted by the device to one or more of the accessory the BMS the server and a vehicle system
causing the device to display an alert for the user on the device
the other action including one or both of scheduling a maintenance appointment and create a record accessible by a service provider, the record indicating the one or more determined maintenance actions;
the other action including causing the BMS to switch to a predetermined operating mode; and
the other action including causing the vehicle system to one or both of:
display another alert; and
disable or enable a driving mode.

33. A method in a device configured to communicate with one or more of an accessory a battery management system, BMS, and a server the method comprising:
obtaining one or more of a vehicle parameter, a battery parameter, and an accessory parameter from one or more of the accessory the BMS and the server and
determining one or more maintenance parameters based on the one or more of the vehicle parameter, the battery parameter, and the accessory parameter; and
determining one or more maintenance actions based on the one or more determined maintenance parameters.

34.-38. (canceled)
